(19) United States
(12) Patent Application Publication
(10) Pub. No.: US 2022/0129010 A1
(43) Pub. Date: Apr. 28, 2022

(54) TRANSPORT ROBOT AND METHOD FOR AUTOMATED PARKING

(71) Applicant: CHEETAH ROBOTIC PARKING SYSTEMS, LLC, New York, NY (US)

(72) Inventor: Ronald Douglas PROSSER, Huntington Beach, CA (US)

(21) Appl. No.: 17/436,645

(22) PCT Filed: Mar. 6, 2020
(86) PCT No.: PCT/US2020/021420

§ 371 Date: Sep. 6, 2021

Related U.S. Application Data
(60) Provisional application No. 62/814,545, filed on Mar. 6, 2019.
(60) Provisional application No. 62/814,557, filed on Mar. 6, 2019.

(51) Int. Cl. G05D 1/02; B65G 1/04; B60P 3/06; B62D 63/02; E04H 6/36; E04H 6/42

(52) U.S. Cl. CPC G05D 1/0297; B65G 1/0492; E04H 6/424; B62D 63/025; E04H 6/36; B60P 3/06

(57) ABSTRACT

A transport robot includes a body, a CPU assembly configured for mechanical engagement and electrical coupling with the body, a battery assembly configured for mechanical engagement and electrical coupling with the body in electrical communication with the CPU assembly, at least one powered drive assembly configured for mechanical engagement and electrical coupling with the body in electrical communication with at least one of the CPU assembly or the battery assembly, and at least one mechanical operator assembly configured for mechanical engagement with the body and at least one of mechanical or electrical communication therewith. An automated parking system includes a central control system having supervisory control and configured to provide instructions for a task to be accomplished, and a plurality of transport robots, at least one of which is configured to receive the instructions from the central control system and exercise local control to accomplish the task.

### CROSS-REFERENCE TO RELATED APPLICATIONS

This application claims the benefit of, and priority to, U.S. Provisional Patent Application No. 62/814,545, titled “SYSTEMS AND METHODS FOR HIGH-DENSITY AUTOMATED PARKING,” filed on, Mar. 6, 2019, and U.S. Provisional Patent Application No. 62/814,557, titled “TRANSPORT ROBOTS AND SYSTEMS FOR AUTOMATED PARKING, INVENTORY, STORAGE, AND LIKE SYSTEMS,” filed on Mar. 6, 2019, the entire contents of each of which is hereby incorporated herein by reference.

### BACKGROUND

### 1. Technical Field

The present disclosure relates generally to transport devices, systems, and methods; and, more specifically, to transport robots, systems, and methods for use in automated parking systems, e.g., high-density automatic parking systems, automated inventory systems, automated storage systems, and the like.

### 2. Background of Related Art

Prior transport systems operate using one or more transfer carts that move one or more robotic carts in one direction, e.g., the X direction, before deploying the robotic cart(s) for movement in another direction, e.g., the Y direction. The transfer carts are configured to move along tracks or rails. The robotic carts, although not typically confined to movement along tracks or rails as are the transfer carts, still have little or no ability to turn. Rather, they move in a single direction, along a column, from the transfer cart, to objects to retrieve or drop off one or more objects, and back to the transfer cart. Such robotic carts may also require turntables to reorient the carts in a desired direction.

Prior robotic carts, as well as the transfer carts and/or turntables used therewith, are mechanically-intensive components subject to wear and tear, breakdown, and other issues. These issues may degrade throughput of the system and, in some cases, partially or fully bring operation of the system to a halt.

### SUMMARY

Aspects and features of the present disclosure are detailed below. To the extent consistent, any or all of the aspects described herein may be used in conjunction with any or all of the other aspects described herein.

The present disclosure provides transport robots and systems for use in automated parking systems, automated inventory systems, automated storage systems, and the like. The transport robots and systems of the present disclosure eliminate wasted space by not requiring transfer carts or turn tables; overcome failures with no service interruption; are capable of maneuvering behind columns, stairways, elevator shafts, and other obstacles; and provide a sufficiently low profile to be capable of fitting underneath vehicles (e.g., the four inch height clearance of 99% of production cars), pallets, and other objects. This short form factor allows the transport robot to perform all required tasks without the need of a pallet or other ancillary equipment, thus freeing the transport robot from the constraints posed by pallets and the like.

Provided in accordance with aspects of the present disclosure is a transport robot including a body and a plurality of sub-assemblies. At least one of the sub-assemblies is configured to releasably mechanically engage and electrically couple with the body. Each of the plurality of sub-assemblies is configured to at least one of electrically or mechanically coupled to at least one other of the plurality of sub-assemblies via the body. The plurality of sub-assemblies includes a CPU sub-assembly configured for mechanical engagement and electrical coupling with the body, a battery sub-assembly configured for mechanical engagement and electrical coupling with the body in electrical communication with the CPU sub-assembly, at least one powered drive sub-assembly configured for mechanical engagement and electrical coupling with the body in electrical communication with at least one of the CPU sub-assembly or the battery sub-assembly, and at least one mechanical operator sub-assembly configured for mechanical engagement with the body and at least one of mechanical or electrical communication therewith.

In an aspect of the present disclosure, the transport robot further includes a cover disposed about at least a portion of the body and enclosing the CPU sub-assembly, the battery sub-assembly, and the at least one powered drive sub-assembly within the body.

In another aspect of the present disclosure, the CPU sub-assembly is configured to releasably mechanically engage and electrically couple with the body. In such aspects, the CPU sub-assembly and the body may include corresponding electrical connections configured to electrically connect to one another upon mechanical engagement of the CPU sub-assembly within a cavity defined within with the body.

In yet another aspect of the present disclosure, the battery sub-assembly is configured to releasably mechanically engage and electrically couple with the body. In such aspects, the battery sub-assembly and the body may include corresponding electrical connections configured to electrically connect to one another upon mechanical engagement of the battery sub-assembly within a cavity defined within with the body.

In still another aspect of the present disclosure, the at least one powered drive sub-assembly is configured to releasably mechanically engage and electrically couple with the body. In such aspects, the at least one powered drive sub-assembly may be configured to slidably mechanically engage the body. Additionally or alternatively, the at least one powered drive sub-assembly may include a plug configured to releasably electrically couple with a receptacle of the body.

In another aspect of the present disclosure, the at least one powered drive sub-assembly includes a frame, a steering motor, a drive motor, and a wheel assembly. In such aspects, the at least one powered drive sub-assembly may be configured to selectively disengage at least one of the steering motor or the drive motor from the wheel assembly to permit at least one of free rotation or free rolling of the wheel assembly.

In still yet another aspect of the present disclosure, the body defines a rectangular configuration and the at least one powered drive sub-assembly includes four powered drive sub-assemblies each disposed adjacent a corner of the body. In such aspects, each powered drive sub-assembly may include an “L”-shaped or “U”-shaped rail arrangement configured to mechanically slidably engage an “L”-shaped or “U”-shaped bar arrangement at one of the corners of the body.

In another aspect of the present disclosure, the at least one mechanical operator sub-assembly is configured to releasably mechanically engage the body.

In yet another aspect of the present disclosure, the at least one mechanical operator sub-assembly is configured to receive at least one of a mechanical input or an electrical input from the body to operate the at least one mechanical operator sub-assembly. In such aspects, the at least one mechanical operator sub-assembly may include a pair of arms configured to pivot relative to one another and the body to manipulate an object.

In still another aspect of the present disclosure, the at least one mechanical operator sub-assembly includes a pair of mechanical operator sub-assemblies disposed on opposing sides of the body.

In another aspect of the present disclosure, the transport robot further includes at least one sensor sub-assembly disposed on the body.

In still yet another aspect of the preset disclosure, the transport robot further includes at least one pair of towing magnets disposed on the body or at least one towing electromagnet disposed on the body.

In aspects of the present disclosure, the transport robot defines a vertical clearance of no greater than 4 inches.

The present disclosure also provides systems and methods for, e.g., high density automated parking, that eliminate the need for transfer carts and turntables and reduce the required space around elevators, thereby freeing up as much as 15%-20% of additional parking space as compared to prior automated parking systems. These systems and methods of the present disclosure also create a significant increase in vehicle throughput during normal operation as compared to prior automated parking systems and minimize disruptions and reductions in vehicle throughput resulting from failure(s). These systems and methods of the present disclosure provide the above without the need for specialized infrastructure, e.g., machinery, equipment, etc., built into the parking structure itself. As such, the systems and methods of the present disclosure can be deployed for use with any suitable parking structure without (or without significant) adaptation required.

Provided in accordance with aspects of the present disclosure are automated parking systems and methods including a central control system and a plurality of transport robots. The central control system has supervisory control and is configured to provide instructions for a task to be accomplished, while each transport robot is configured for rotation, movement in an X-direction, and movement in a Y-direction. At least one of the transport robots is configured to receive the instructions from the central control system and exercise local control to direct at least one of rotation, movement in an X-direction, or movement in a Y-direction of at least one of the transport robots to accomplish the task.

In an aspect of the present disclosure, the supervisory control of the central control system allows the central control system to override the local control of the at least one transport robot.

In another aspect of the present disclosure, the plurality of transport robots includes at least one pair of transport robots. Each pair of transport robots includes a lead transport robot and a follower transport robot.

In yet another aspect of the present disclosure, the supervisory control of the central control system allows the central control system to reassign lead and follower roles amongst the plurality of transport robots.

In still another aspect of the present disclosure, the lead transport robot in each pair of transport robots provides control functions for that pair of transport robots in all aspects and the other (follower) transport robot in each pair of transport robots complies with the lead transport robot of that pair in all control aspects. Assignment of the lead function between the two transport robots may be made by the robots themselves, may be done by the central controller, or may be made by some combination of the these. Factors considered in making the lead selection include health status of the individual robots and/or other operational factors. The lead robot may or may not be physically in front of the second robot in order to provide control functions for both robots.

In another aspect of the present disclosure, the plurality of transport robots includes at least one pair of transport robots. Each pair of transport robots includes a first transport robot and a second transport robot. The first transport robot in each pair of transport robots is physically in front of the second transport robot of that pair of transport robots in some aspects and trails the second transport robot of that pair in other aspects. Which transport robot is in physically in front may thus be independent of which transport robot provides control for the pair.

In still yet another aspect of the present disclosure, the plurality of transport robots are organized into a plurality of pairs of transport robots with, in aspects, one pair of transport robots configured to transport a vehicle.

In an aspect of the present disclosure, when one of the transport robots become disabled, the disabled transport robot and the other transport robot paired therewith are replaced with a replacement pair of transport robots to complete the task. In such aspects, the other transport robot paired with the disabled transport robot may be configured to tow the disabled transport robot.

In another aspect of the present disclosure, when one of the transport robots become disabled, the other transport robot paired therewith is unpaired from the disabled robot and paired with a substitute transport robot to complete the task. In such aspects, a tow transport robot may be configured to tow the disabled transport robot.

In yet another aspect of the present disclosure, a ratio of a number of pairs of transport robots to a number of parking stalls on a floor of a parking structure is up to 1:15; up to 1:25; or up to 1:40. In aspects, the ratio is between 1:5 and 1:40.

In still another aspect of the present disclosure, a ratio of a number of elevators on a floor of a parking structure to a number of pairs of transport robots is up to 1:10; up to 1:20; or up to 1:30. In aspects, the ratio is between 1:2 and 1:40.

In still yet another aspect of the present disclosure, the task to be accomplished is retrieval of a vehicle blocked by at least one blocking vehicle. Additionally or alternatively, the task to be accomplished is a housekeeping operation to organize empty spaces in a pre-determined manner.

In an aspect of the present disclosure, the plurality of transport robots are configured to park vehicles in rows in accordance with an alignment such that each row define a linear, unobstructed path extending underneath the vehicles in that row. The alignment may be one of a front wheel alignment, a rear wheel alignment, or a center line alignment.

In another aspect of the present disclosure, sensors configured to sense encroachments into the unobstructed path of each row are provided.

### BRIEF DESCRIPTION OF THE DRAWINGS

Various aspects and features of the present disclosure are described hereinbelow with reference to the drawings wherein like numerals designate identical or corresponding elements in each of the several views.

FIGS. 1A-1C are block diagrams illustrating various communication configurations between a central control system and a plurality of transport robots of a system provided in accordance with the present disclosure;

FIG. 2 is a perspective view of a transport robot provided in accordance with the present disclosure;

FIG. 3 is a perspective view of the transport robot of FIG. 2 with the entire cover exploded therefrom;

FIG. 4 is a perspective view of the transport robot of FIG. 2 with a portion of the cover and a battery assembly exploded therefrom;

FIG. 5 is an enlarged, perspective view of the area of detail indicated as “5” in FIG. 3;

FIG. 6A is a perspective view of the transport robot of FIG. 2 with the cover removed;

FIG. 6B is a top view of the transport robot of FIG. 2 with the cover removed;

FIG. 7 is a perspective view of a portion of the transport robot of FIG. 2 with the cover removed and one of the powered drive sub-assemblies shown partially removed;

FIG. 8 is a perspective view of a portion of the transport robot of FIG. 2 with the cover removed and one of the mechanical operator sub-assemblies shown partially removed;

FIG. 9A is a perspective view of the transport robot of FIG. 2 with arms thereof disposed in a retracted position;

FIG. 9B is a perspective view of the transport robot of FIG. 2 with the arms disposed in a partially extended position;

FIG. 9C is a perspective view of the transport robot of FIG. 2 with the arms disposed in a fully extended position;

FIG. 10A is an end view of the transport robot of FIG. 2;

FIG. 10B is a side view of the transport robot of FIG. 2;

FIG. 11 is a perspective view of a pair of transport robots of the present disclosure disposed in end-to-end relation; and

FIGS. 12A and 12B are perspective views of a pair of transport robots of the present disclosure being oriented for towing;

FIG. 13 is a perspective view of another pair of transport robots of the present disclosure oriented for towing;

FIG. 14A is a perspective view of another transport robot in accordance with the present disclosure similar to the transport robot of FIG. 2 and shown with cover removed;

FIG. 14B is a top view of the transport robot of FIG. 14A with the cover removed;

FIG. 15 is a schematic illustration of still another transport robot in accordance with the present disclosure similar to the transport robot of FIG. 2, shown with one of the powered drive sub-assemblies partially removed;

FIG. 16 is a schematic illustration of one of the powered drive sub-assemblies of the transport robot of FIG. 15;

FIGS. 17A-17J are schematic drawings progressively illustrating retrieval of a vehicle from a portion of a parking structure utilizing a prior automated parking system;

FIG. 18 is a plan view of a floor of a parking structure incorporating the prior automated parking system of FIGS. 17A-17J;

FIGS. 19A-19C are schematic drawings progressively illustrating retrieval of a vehicle from a portion of a parking structure utilizing an automated parking system of the present disclosure;

FIG. 20 is a plan view of a floor of a parking structure incorporating the automated parking system of FIGS. 19A-19C;

FIGS. 21A-211 are plan views of the floor of the parking structure of FIG. 20 progressively illustrating coordinated movement of the plurality of transport robots of the automatic parking system of FIGS. 19A-19C preparing for retrieval of a vehicle, retrieving a vehicle, and preparing for retrieval of a subsequent vehicle;

FIGS. 22A-22E are schematic drawings progressively illustrating removal of and compensation for a disabled transport robot without compromising system function;

FIGS. 22F-22K are schematic drawings progressively illustrating isolation and subsequent removal of and compensation for a disabled transport robot without compromising system function;

FIG. 23 is a block diagram illustrating a floor layout of a parking structure including areas near the elevators that are suited for special, oversized, or other vehicles;

FIG. 24 is a block diagram illustrating transport robots moving relative to a vehicle;

FIGS. 25A-25C are block diagrams illustrating the various rotational and direction movement capabilities of the transport robots of the present disclosure;

FIGS. 26A-26D are schematic drawings progressively illustrating positioning of a pair of transport robots relative to a vehicle for transporting the vehicle;

FIG. 27 is a schematic drawing illustrating the various points of entry for transport robots carrying a vehicle onto an elevator;

FIGS. 28A-28C are schematic drawings illustrating various alignments of vehicles in the automatic parking system of FIGS. 19A-19C;

FIG. 29 is a schematic drawing illustrating an unobstructed path below vehicles and associated sensors for monitoring the unobstructed path;

FIG. 30 is a simplified, side view illustrating the unobstructed path below a vehicle; and

FIG. 31 is a simplified, side view illustrating a vehicle disposed within an entry stall of the automated parking system of FIGS. 19A-19C.

### DETAILED DESCRIPTION

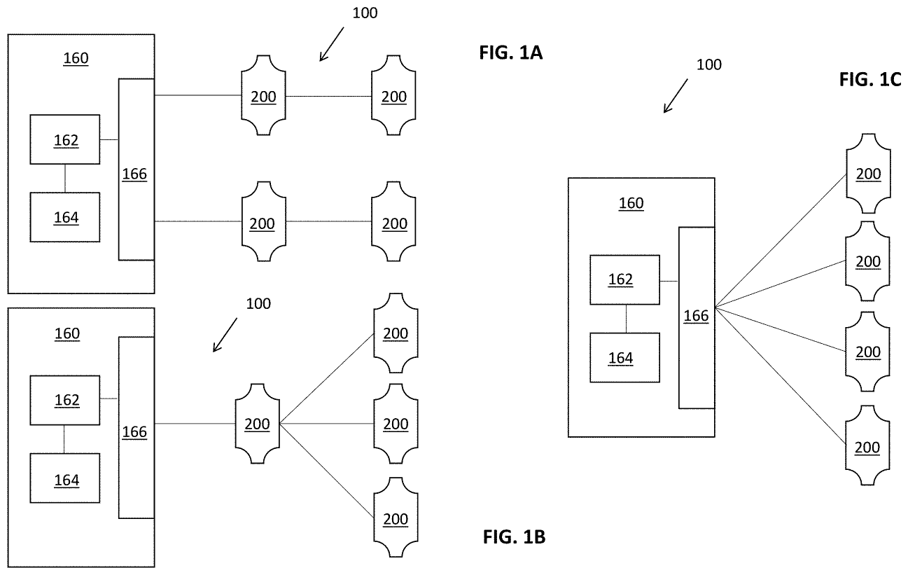

Referring to FIGS. 1A-1C, a system 100 provided in accordance with the present disclosure includes a central control system 160 and a plurality of transport robots 200 (which may be identical to one another or different from one another). System 100 may be configured as part of an automated parking system, an automated inventory system, an automated storage system, etc.

Central control system 160 of system 100 may include one or more virtual or physical computers incorporated into or across one or more servers, tablets, smartphones, desktop computers, laptop computers, kiosks, or the like. Where multiple computers are provided, such may be connected via hardwire connection or wireless connection and/or some of all of the computers may be local, e.g., within a local intranet, or remote, e.g., connected via the internet.

Central control system 160 includes one or more processors 162 and one or more associated non-transitory memories 164 storing instructions to be carried out by the one or more processors 162 to perform the operations of central control system 160. Central control system 160 further includes an input/output 166 to enable central control system 160 to communicate with one or more of transport robots 200. More specifically, central control system 160 is configured to, directly or indirectly, communicate with the plurality of transport robots 200 to coordinate performance of desired tasks, perform a housekeeping operation, direct one or more transport robots 200 to a maintenance station, direct one or more transport robots 200 to a charging station, activate one or more transport robots 200, deactivate one or more transport robots 200, etc.

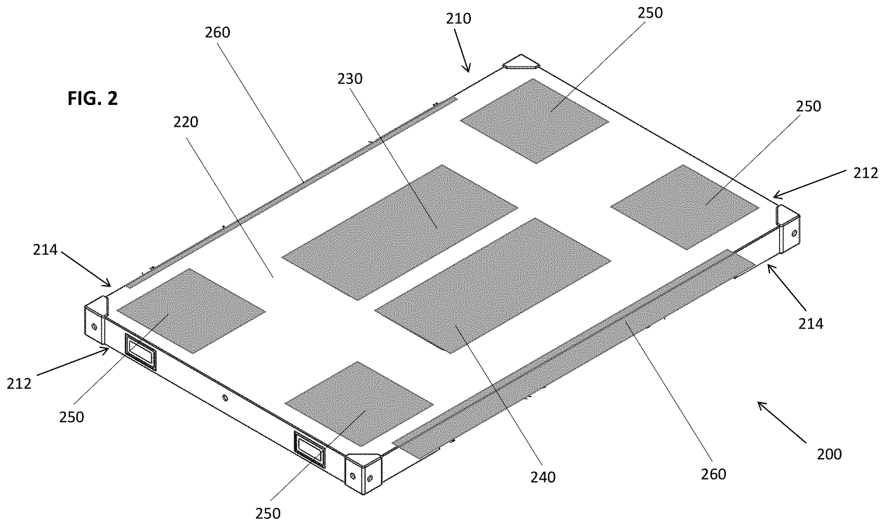

Central control system 160 directs transport robots 200 where to go, what actions to take, route planning, re-planning, and all other higher level decisions. However, transport robots 200 themselves include onboard controls, e.g., onboard CPU subassemblies 230 (see FIG. 2), configured to enable transport robots 200 to themselves and/or as groups of two or more transport robots 200, determine how to take the desired actions, how to move/rotate, coordinate with other transport robot 200, position relative to a target object, e.g., a vehicle, engage and lift the target object, avoid collisions, and other local decisions. That is, one or more of the transport robots 200 has local control to carry out a particular task, while central control system 160 retains supervisory control to direct the tasks to be performed and aid transport robots 200 with localization, route planning, etc. In addition, central control system 160 and the transport robots 200 may communicate information relating to, for example, positioning, updating, collision avoidance, docking/charging, maintenance, and logging of data, errors, near-miss events, etc.

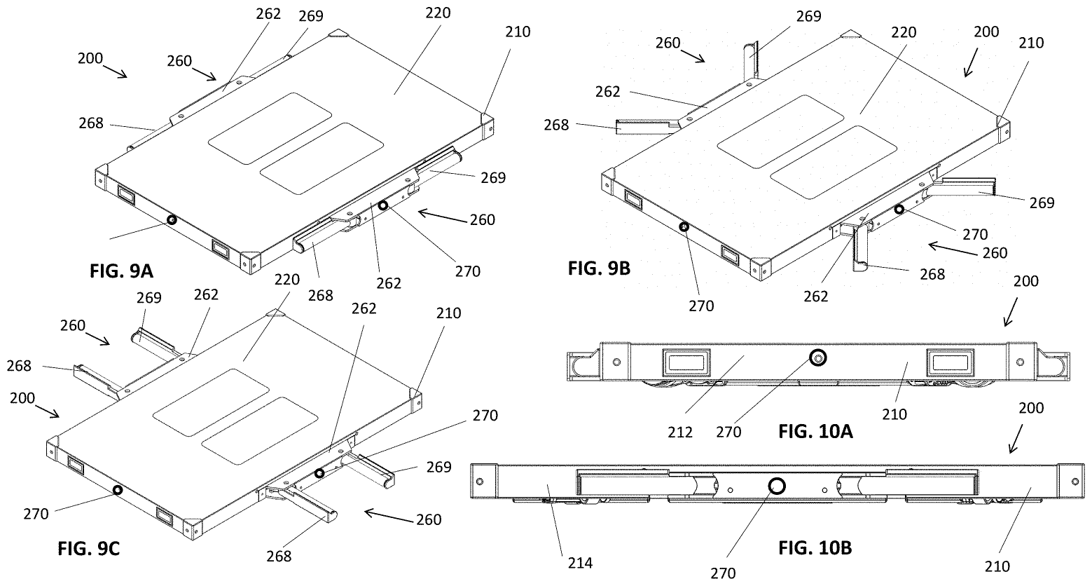

Supervisory control of the transport robots 200 by central control system 160 may also include overriding capability such as, for example, with respect to collision avoidance. Although collision avoidance is in part accomplished by the transport robots 200 at the local level, e.g., via on-board sensor sub-assemblies 270 (FIGS. 9A-10B) and CPU sub-assemblies 230 (FIG. 2) on transport robots 200 indicating the presence of another transport robot 200 or other obstacle and/or local rules governing transport robots 200, as detailed below, central control system 160 may intervene to provide control based upon new or updated priorities and, as a result, slow or stop the lower-priority transport robot(s) 200 to allow the higher priority transport robot(s) 200 to pass first.

Central control system 160 is further configured, for each transport robot 200 and/or the system 100 as a whole, to track: the location, diagnostics, and other information from each transport robot 200, performance history, maintenance history and cycles, performance metrics, emergency services, security systems, etc. Central control system 160 is also configured to maintain position, input, and output information for each target object and account for the same in determining where and how to move and store the objects.

Referring in particular to FIG. 1A, in embodiments, transport robots 200 may cooperate in pairs wherein one of the transport robots 200 directly communicates with central control system 160 and, based upon communicates therewith, directs the other transport robot 200 of the pair accordingly, although the follower transport robot 200 in each pair may likewise be configured to communicate directly with central control system 160 as well. The transport robots 200, in embodiments, may be identical (or different) in hardware, and are configurable (and reconfigurable) via central control system 160 (or other control) to operate in separate capacities. Multiple pairs of transport robots 200 may be provided. With respect to each pair of transport robots 200, the lead transport robot 200 is responsible for decision making, e.g., local command and control functions, for both transport robots 200 as well as communication with other transport robots 200 and/or central control system 160. However, if the lead transport robot 200 fails, the lead role may be reversed. Central control system 160 may also reassign the lead role or assign a different configuration of a pair or group of transport robots 200. For example, the lead/follow assignments of one or more transport robots 200 may be changed in whole or in part via central control system 160 to exploit internal redundancy, thus helping to overcome and/or contain the effects of malfunctions of certain subsystem, e.g., malfunction of navigation of one transport robot 200 can be accounted for by transitioning the lead role for the limited purpose of navigation from the malfunctioned transport robot 200 to another transport robot 200 with healthy navigation. In this way, failed components, sub-systems, sensors, etc., can be readily overcome by the redundancy of multiple transport robots 200, e.g., pairs of transport robots 200, working as a team. Such applies equally to other critical functions including but not limited to off-board communications, collision avoidance, critical on-board maneuver controls, reroute planning and execution, etc.

With reference to FIG. 1B, in other embodiments, one of the transport robots 200 directly communicates with central control system 160 and, based upon communications therewith, directs a plurality of other transport robots 200 accordingly. Multiple “lead” transport robots 200 each directing a plurality of other transport robots 200 may be provided.

As shown in FIG. 1C, in still other embodiments, each transport robot 200 may communicate directly with central control system 160. Combinations of the above configurations illustrated in FIGS. 1A-1C or other suitable configurations are also contemplated.

Referring generally to FIGS. 1A-1C, regardless of the particular communication configuration between transport robots 200 and central control system 160, central control system 160 and/or transport robots 200 communicate such that transport robots 200 work in cooperation, e.g., via plural coordinate maneuvers performed consecutively, simultaneously, or in overlapping temporal relation, with one another to perform tasks. Further, the particular roles, communication configuration, etc. may be modified during use to provide real-time optimization based upon new circumstances or other reasons. In embodiments, redundant local communications to and from all transport robots 200 and/or to and from central control system 160 are provided, e.g., via WiFi or other suitable communications protocols. Each of the transport robots 200, or at least the lead transport robot(s) 200 may periodically, continuously, and/or after each maneuver, store the overall configuration of the operating structure, e.g., parking structure, warehouse, etc., and the objects therein such that, in the event of communication failure, failure of the central control system 160, or other failure, the transport robots 200 can at least perform minimum necessary operational tasks.

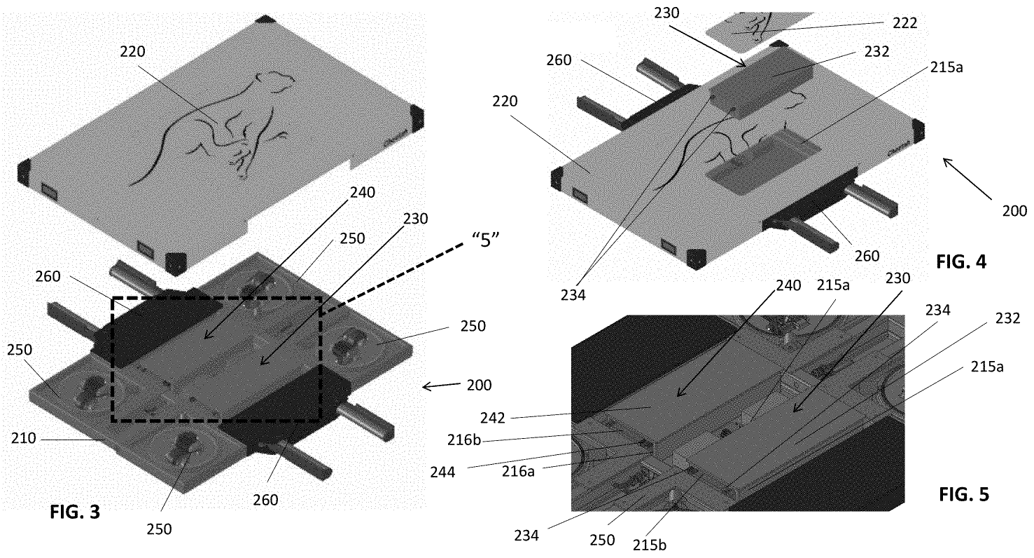

Referring to FIG. 2, one of the transport robots 200 is shown. Transport robot 200 defines, in embodiments, less than or equal to a twelve inch vertical clearance; in other embodiments, less than or equal to an eight inch vertical clearance; and, in still other embodiments, less than or equal to a four inch vertical clearance. Transport robot 200 is robust, capable of withstanding wear and physical contact, and are also weatherproofed (including, for example, sealed bearings, sealed electronic enclosures, etc.) to enable all-weather use. Transport robot 200 is capable of an unloaded speed of at least eight feet per second and a fully loaded (with, e.g., at least a 3,000 lb load or, in other embodiments, at least a 6,000 lb load) speed of at least four feet per second. Transport robot 200 includes a generally rectangular structural body 210 including opposed ends 212 and opposed sides 214, although other suitable configurations of body 210, e.g., circular, oval, other polygonal shape, etc., are also contemplated. Body 210 supports thereon or therein the various components of transport robot 200, as detailed below. A removable cover 220 is disposed about the top of body 210 and at least a portion of the ends 212 and/or sides 214 of body 210 (see also FIGS. 3 and 5) to enclose and protect the internal components of transport robot 200 disposed within body 210 thereof. Cover 220 may be retained about body 210 via one or more snap-fitting engagements, friction-fitting engagements, complementary interlocking engagements, latches, spring pins, screws, bolts, etc. Further, cover 220 may be completely removable from body 210 or may be connected thereto via hinges, slide rails, etc., to enable cover to be displaced via pivoting, sliding etc. relative to body 210, to provide access to the interior of body 210 without fully decoupling cover 220 therefrom.

Transport robot 200 is configured to communicate with central control system 160 (FIGS. 1A-1C) and/or other transport robot(s) 200, has the ability to rotate with zero turning radius, has the ability to move in an “X”-direction, has the ability to move in a “Y”-direction, has the ability to move in diagonal directions including both “X” and “Y” components, has the ability to lift, place, and/or manipulate objects, and may additionally or alternatively have the ability to carry out other mechanical, electrical, and/or electromechanical functions. Further, as detailed below, transport robot 200 defines a modular configuration facilitating ease of removal, repair, and/or replacement of any of the individual sub-assemblies thereof without requiring substantial mechanical disassembly, substantial electrical disconnection, or removal of non-effected components or sub-assemblies. In this manner, no specialized training or equipment is required to remove or replace any of the individual sub-assemblies of transport robot 200.

Transport robot 200, in addition to body 210 and cover 220, includes: at least one CPU sub-assembly 230; at least one battery sub-assembly 240; a plurality, e.g., four, powered drive sub-assemblies 250; at least one, e.g., two, mechanical operator sub-assemblies 260; and, in embodiments, at least one sensor sub-assembly 270 (see FIGS. 10A and 10B). Various electrical connectors, e.g., switches, boxes, lead wires, conductors, contacts, plugs, receptacles, circuit boards, flex circuits, etc., disposed on or within body 210 enable releasable electrical coupling of the various sub-assemblies 230-270 without frustrating the modularity of transport robot 200, as detailed below. Further, one or more of CPU sub-assembly 230, battery sub-assembly 240, powered drive sub-assemblies 250, or mechanical operator sub-assemblies 260 may be plug and play compatible, whereby all that is required is connection to body 210 for one or more of the other sub-assemblies, e.g., CPU sub-assembly 230, to identify the connected sub-assembly and configure use thereof.

With additional reference to FIGS. 3-5, CPU sub-assembly 230 is configured to communicate with other transport robots 200 and/or central control system 160 (see FIGS. 1A-1C) and to control the powered drive sub-assemblies 250 and mechanical operator sub-assemblies 260 based upon programs running thereon (e.g., a navigation system), control instructions received from other transport robots 200 and/or central control system 160 (see FIGS. 1A-1C), and feedback received from, for example, sensor sub-assemblies 270 (see FIGS. 10A and 10B). To this end, CPU sub-assembly 230 includes one or more processors, one or more associated non-transitory memories storing instructions to be carried out by the one or more processors, one or more storage devices to store data collected and received, and one or more input/output devices to enable communication, e.g., local wired and remove wireless communication. CPU sub-assembly 230 is powered by battery sub-assembly 240 and, in embodiments, may communicate therewith to control charging of battery sub-assembly 240 and/or discharging of battery sub-assembly 240 such as, for example, depending upon a state of transport robot 200, e.g., a high-performance use mode, a regular use mode, a power saver use mode, an idle mode, a sleep mode, etc.

CPU sub-assembly 230 further includes an outer enclosure 232 that houses and protects the internal electrical components of CPU sub-assembly 230. Outer enclosure 232 is configured for receipt and mechanical engagement within a first cavity 215a defined within body 210 in any suitable manner, e.g., via one or more snap-fitting engagements, friction-fitting engagements, complementary interlocking engagements, spring pins, latches, screws, bolts, etc. Exposed electrical connectors 234 of CPU sub-assembly 230 extend through outer enclosure 232 and are configured to mate with a corresponding electrical connector block 215b disposed within first cavity 215a of body 210 upon receipt of CPU sub-assembly 230 within first cavity 215a to electrically couple CPU sub-assembly 230 with body 210, although contactless electrical connections are also contemplated. As can be appreciated, electrical coupling of electrical connectors 234 and connector block 215b enable communication to/from CPU sub-assembly 230. Electrical connectors 234 and connector block 215b may define any suitable configuration enabling electrical coupling therebetween upon receipt of CPU sub-assembly 230 within first cavity 215a, e.g., brush connections, spring connections, male-female connections, etc. In embodiments, mechanical and electrical coupling of CPU sub-assembly 230 with body 210 may be accomplished in a manner similar to the engagement of laptop battery within a laptop, engagement of a smartphone battery within a smartphone, or engagement of any other known modular electrical or electromechanical system.

Continuing with reference to FIGS. 2-5, a top portion of outer enclosure 232 of CPU sub-assembly 230 may define a portion of cover 220 (with cover 220 defining a complementary cut-out for receipt of the top portion of outer enclosure 232) or cover 220 may include a removable section 222 to provide access to CPU sub-assembly 230 (see FIG. 4). In either configuration, selective access to CPU sub-assembly 230 for installation, removal, and/or replacement thereof is provided without the need to remove the entirety of cover 220. In other embodiments, cover 220 is removed to provide access to CPU sub-assembly 230 (see FIG. 3).

Referring to FIGS. 3 and 5, battery sub-assembly 240 is configured to power the various other sub-assemblies of transport robot 200, e.g., CPU sub-assembly 230, powered drive sub-assemblies 250, mechanical operator sub-assemblies 260, and, in embodiments where provided, sensor sub-assemblies 270 (see FIGS. 10A and 10B). Battery sub-assembly 240 includes a rechargeable battery including one or more battery cells. The rechargeable battery may be, for example, a lithium-ion battery, a lithium-ion polymer battery, a lead-acid battery, a nickel-cadmium battery, a nickel-metal hydride battery, a zinc-air battery, a molten-salt battery, or any other suitable rechargeable battery. Battery sub-assembly 240 may further include a battery controller configured to control charge and discharge of the battery and to monitor battery performance, capacity, and other battery metrics. Battery sub-assembly 240 may be configured to provide sufficient power for normal usage operation of at least one hour and/or may be configured to charge from 0% capacity to 90% capacity in less than three hours.

Battery sub-assembly 240, similar to CPU sub-assembly 230, further includes an outer enclosure 242 configured for receipt and mechanical engagement within a second cavity 216a defined within body 210 in any suitable manner Battery sub-assembly 240 further includes exposed electrical connectors 244 configured to electrically couple with a corresponding electrical connector block 216b disposed within second cavity 216a of body 210 upon receipt of battery sub-assembly 240 within second cavity 216a to electrically couple battery sub-assembly 240 with body 210, although contactless electrical connections are also contemplated. A top portion of outer enclosure 242 of battery sub-assembly 240 may define a portion of cover 220 (with cover 220 defining a complementary cut-out for receipt of the top portion of outer enclosure 242), cover 220 may include a removable section to provide access to battery sub-assembly 240, or cover 220 may be removed to provide access to battery sub-assembly 240.

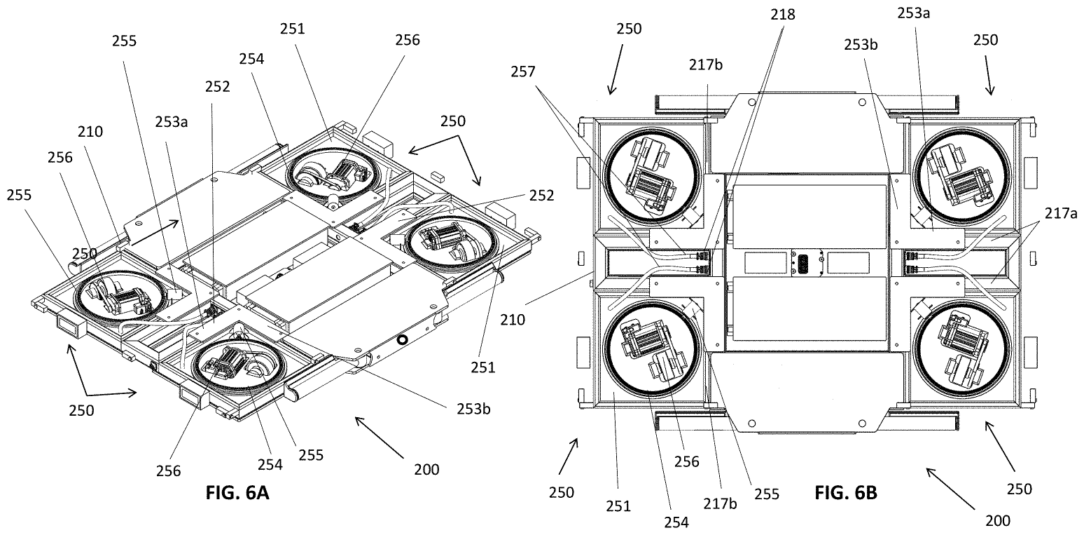

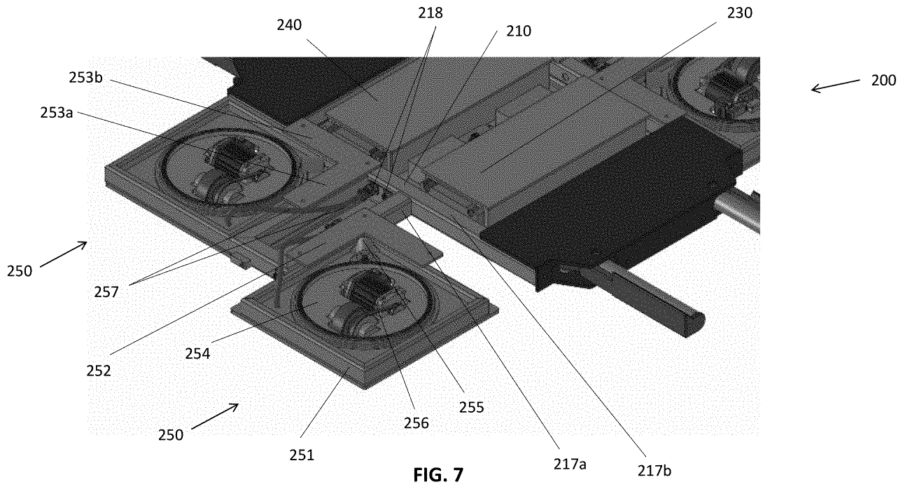

Referring to FIGS. 6A-7, four powered drive sub-assemblies 250 are provided, generally arranged such that each powered drive sub-assembly 250 is positioned at one of the corners of body 210, although other configurations are also contemplated. Powered drive sub-assemblies 250 are universal in that any powered drive sub-assembly 250 may be positioned at any corner of body 210 and are independently and collectively operable. Each powered drive sub-assembly 250 is configured for releasable engagement with body 210. More specifically, each powered drive sub-assembly 250 includes a frame 251 defining a rail 252 configured to slide about a first bar 217a of body 210 into alignment and engagement with body 210. Rail 252, in embodiments, may define a pair of rail segments 253a, 253b disposed in perpendicular orientation relative to one another to define an “L”-shaped or “U”-shaped configuration wherein one rail segment 253a is configured to slide about a first bar 217a of body 210 and the other rail segment 253b is configured to receive and engage a second bar 217b of body 210 (where the bars 217a, 217b likewise define an “L”-shaped or “U”-shaped configuration), thus facilitating engagement of the frame 251 of each powered drive sub-assembly 250 with body 210 at one of the corners of body 210. Engagement between frame 251 and body 210 may be maintained in any suitable manner such as, for example, via one or more snap-fitting engagements, friction-fitting engagements, complementary interlocking engagements, spring pins, latches, screws, bolts, etc.

Each powered drive sub-assembly 250 further includes a wheel assembly 254 rotatably disposed within frame 251, a steering motor 255 configured to rotate wheel assembly 254 to a desired orientation to enable steering of the transport robot 200, a drive motor 256 configured to drive wheel assembly 254 to propel the transport robot 200, and an electrical plug 257 configured to connect to each powered drive sub-assembly 250 to a corresponding electrical receptacle 218 of body 210. Electrical receptacle 218 is electrically coupled, e.g., via wires, switches, connectors, etc. of body 210, to electrical connector block 215b and/or electrical connector block 216b (see FIG. 5) to enable transmission of control and/or power signals from CPU sub-assembly 230 and/or battery sub-assembly 240 to each powered drive sub-assembly 250. Electrical plug 257 is removable from the corresponding electrical receptacle 218 such that, upon disconnection, the powered drive sub-assembly 250 may be slide out of engagement with body 210 and removed therefrom, e.g., for repair or replacement.

Each wheel assembly 254 may be configured to rotate at least 180 degrees relative to its frame 251. The four wheel assemblies 254, working in concert, enable 360 degree rotation of transport robot 200 at zero turning radius, with each wheel assembly 254 only rotating up to 180 degrees to achieve the 360 degree rotation, although other configuration are also contemplated such as, for example: at least 270 degrees of rotation; at least 359 degrees of rotation; or infinite rotation. Each wheel assembly 254 is capable of being steered, e.g., via the steering motor 255 thereof, and driven, e.g., via the drive motor 256 thereof, independently or in cooperating with the other wheel assemblies 254. Further, the steering motor 255 and drive motor 256 of each powered drive sub-assembly 250 are coupled to the wheel assembly 254 via clutches or other suitable disconnect mechanisms that enable selective disengagement of the steering motor 255 and/or drive motor 256 from the wheel assembly 254. This configuration enables the wheel assembly 254 to be disengaged and rotate and/or roll freely in the event of failure of the steering motor 255 and/or drive motor 256. This is advantageous in that it allows the transport robot 200, with at least one fully operational powered drive sub-assembly 250 (with the non-operational powered drive sub-assembly(s) 250 set such that the wheel assembly(s) 254 is freely rotating and/or rolling), to still perform the same functions as a fully operational transport robot 200, albeit at a slower pace.

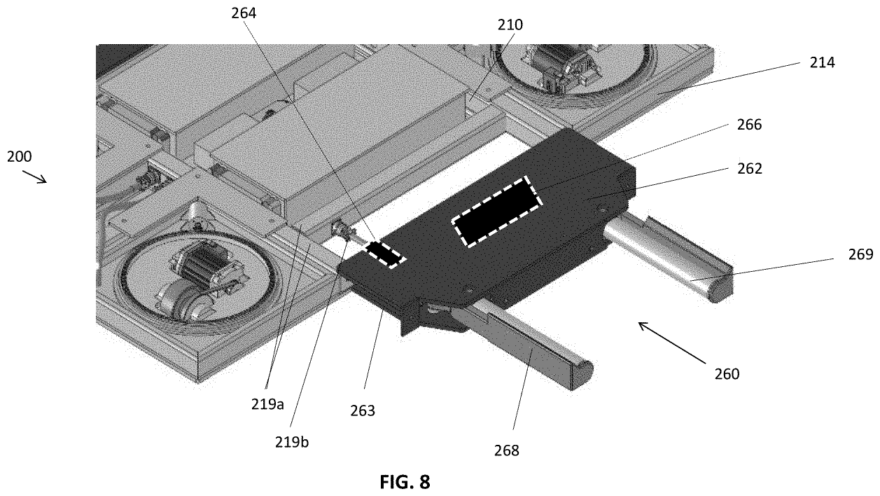

Turning to FIG. 8, two mechanical operator sub-assemblies 260 are provided, generally arranged on the opposing sides 214 of body 210, although other configurations are also contemplated. Mechanical operator sub-assemblies 260 are independently or collectively operable, are configured to releasably engage body 210, and are universal in that each may be positioned on either side 214 of body 210. Each mechanical operator sub-assembly 260 includes a frame 262 defining a generally U-shaped channel 263 about a portion of the perimeter thereof that is configured to slidably receive a U-shaped bar 219a defining a cut-out within body 210 to align and engage the mechanical operator sub-assembly 260 with body 210. Engagement between frame 262 and body 210 may be maintained in any suitable manner such as, for example, via one or more snap-fitting engagements, friction-fitting engagements, complementary interlocking engagements, spring pins, latches, screws, bolts, etc.

Each mechanical operator sub-assembly 260 further includes a female receptacle 264 which may be an electrical receptacle, a mechanical receptacle, or an electromechanical receptacle. Female receptacle 264 is configured to receive a male input 219b of body 210 to establish electrical, mechanical, or electromechanical communication therebetween, although this male-female arrangement may be reversed or other suitable connections provided. In embodiments, each mechanical operator sub-assembly 260 further includes an on-board motor assembly 266. In such embodiments, female receptacle 264 and male input 219b are configured to electrically connect to one another to provide power and/or control signals to the on-board motor assembly 266 to drive operation thereof. Male input 219b, in such embodiments, is electrically coupled, e.g., via wires, switches, connectors, etc. of body 210, to electrical connector block 215b and/or electrical connector block 216b (see FIG. 5) to enable transmission of control and/or power signals from CPU sub-assembly 230 and/or battery sub-assembly 240 to mechanical operator sub-assembly 260.

Alternatively, in embodiments, mechanical operator sub-assembly 260 does not include an on-board motor assembly 266 but instead includes internal gearing and/or other mechanical components. In such embodiments, female receptacle 264 and male input 219b are configured to mechanically connect to one another to provide mechanical inputs to the mechanical components to drive operation thereof. In these embodiments, a drive motor (not shown) may be disposed on or within body 210 for driving male input 219b. The drive motor, in such embodiments, is electrically coupled, e.g., via wires, switches, connectors, etc. of body 210, to electrical connector block 215b and/or electrical connector block 216b (see FIG. 5) to enable transmission of control and/or power signals from CPU sub-assembly 230 and/or battery sub-assembly 240 for conversion into a mechanical input (by the motor) provided to mechanical operator sub-assembly 260. In still other embodiments, both mechanical and electrical communications are established between female receptacle 264 and male input 219b.

Referring also to FIGS. 9A-9C, although one configuration of a mechanical operator sub-assembly 260 is detailed below, it is contemplated that any suitable similar or different mechanical operator sub-assemblies 260 may be utilized. Mechanical operator sub-assembly 260 includes first and second arms 268, 269 pivotably coupled to frame 262 and pivotable relative thereto between storage positions (see FIG. 9A), wherein arms 268, 269 are substantially parallel, e.g., within about 15 degrees of parallel, with one another and sides 214 of body 210, and deployed positions (see FIG. 9C), wherein arms 268, 269 are substantially perpendicular, e.g., within about 15 degrees of perpendicular, with one another and sides 214 of body 210. Arms 268, 269 may further be pivoted to any intermediate position (see FIG. 9B) between the storage and deployed positions.

Arms 268, 269 may define curved and/or ramped opposing surfaces such that, upon positioning of arms 268, 269 with a vehicle tire therebetween and pivoting of arms 268, 269 to the deployed position, arms 268, 269 engaged the vehicle tire on either side thereof and lift the vehicle tire off the ground. In this manner, the arms 268, 269 of each mechanical operator sub-assembly 260 of transport robot 200 may engage and lift one set of vehicle tires, e.g., the front tires, while the arms 268, 269 of each mechanical operator sub-assembly 260 of another transport robot 200 engage and lift the other set of vehicle tires, e.g., the rear tires, thus enabling transport of the vehicle using the pair of transport robots 200. Arms 268, 269 may additionally or alternatively be configured for other pivotable motion, in or out of plane, and/or may be configured for other motion, e.g., translational motion or rotational motion. Further still, greater or fewer arms may be provided, the arms may be configured to articulate with plural degrees of freedom about one or more joints, the arms may include end effectors for grasping or otherwise manipulating objects or performing functions (mechanical, electrical, or electromechanical functions), and/or different movable structures, in place of or in addition to arms, may be provided. Depending upon the desired use of transport robot 200, mechanical operator sub-assemblies 260 (similar or different from one another) of suitable configuration may be selected and engaged with body 210.

With reference to FIGS. 9A-10B, in embodiments, as noted above, transport robot 200 may include at least one sensor sub-assembly 270. One or more sensor sub-assemblies 270 may be disposed along either or both of the ends 212 and/or sides 214 of body 210 or in other suitable positions. The sensor sub-assemblies 270 may include any suitable sensors such as, for example, cameras, proximity sensors, motion-activated sensors, RFID or other identification sensors, Doppler sensors, collision-avoidance sensors, etc. The sensor sub-assemblies 270 are electrically coupled, e.g., via wires, switches, connectors, etc. of body 210, to electrical connector block 215b and/or electrical connector block 216b (see FIG. 5) to enable transmission of control and/or power signals from CPU sub-assembly 230 and/or battery sub-assembly 240 and to enable sensed data transmission from sensor sub-assemblies 270 to CPU sub-assembly 230 (FIG. 2) for use in controlling transport robot 200 and/or communication with other transport robots 200 and/or central control assembly 160 (FIGS. 1A-1C).

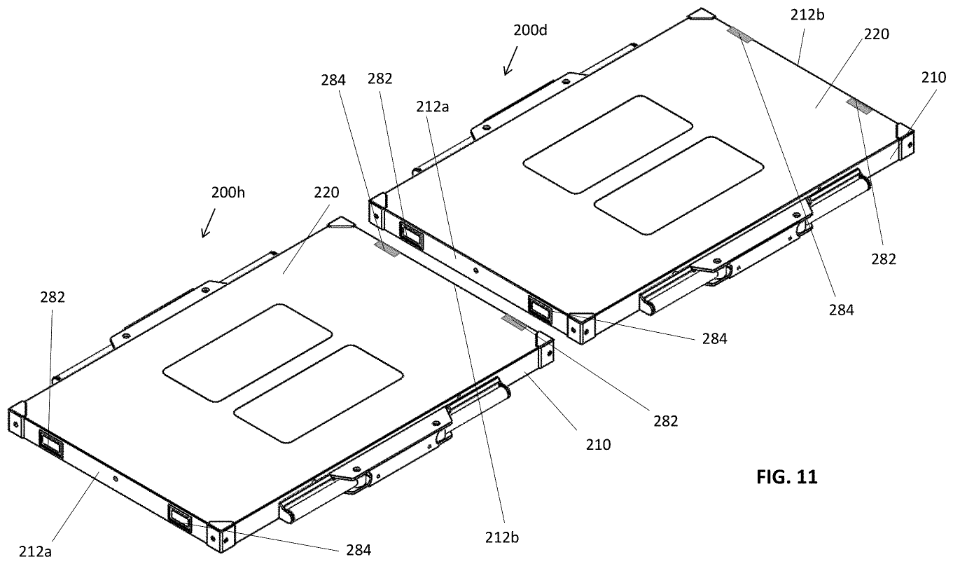

Referring to FIG. 11, transport robots 200 may include tow features to enable a healthy transport robot 200h to engage a disabled transport robot 200d and tow the disabled transport robot 200d out of the way, to a maintenance station, or to another suitable location. In embodiments, the tow features may be in the form of magnet pairs 282, 284 disposed at spaced-apart positions on the leading and trailing ends 212a, 212b, respectively, of the body 210 of each transport robot 200h, 200d. Magnets 282, 284 may be configured to exhibit opposite polarities. In this manner, when transport robots 200h, 200d are positioned in end-to-end manner, e.g. with the trailing end 212b of transport robot 200h positioned adjacent the leading end 212a of transport robot 200d, the pairs of magnets 282, 284 of the trailing end 212b of transport robot 200h are aligned with opposite polarity magnets 284, 282 of the leading end 212a of transport robot 200d. As such, upon sufficient approximation of the trailing end 212b of transport robot 200h with the leading end 212a of transport robot 200d, the magnet pairs 282, 284 and 284, 282 attract and engage one another, thereby coupling the transport robots 200h, 200d with one another to enable the healthy transport robot 200h to tow the disabled transport robot 200d. Magnetic engagement and towing may also be accomplished in the opposite manner, e.g., by positioning the leading end 212a of transport robot 200h adjacent the trailing end 214a of transport robot 200d.

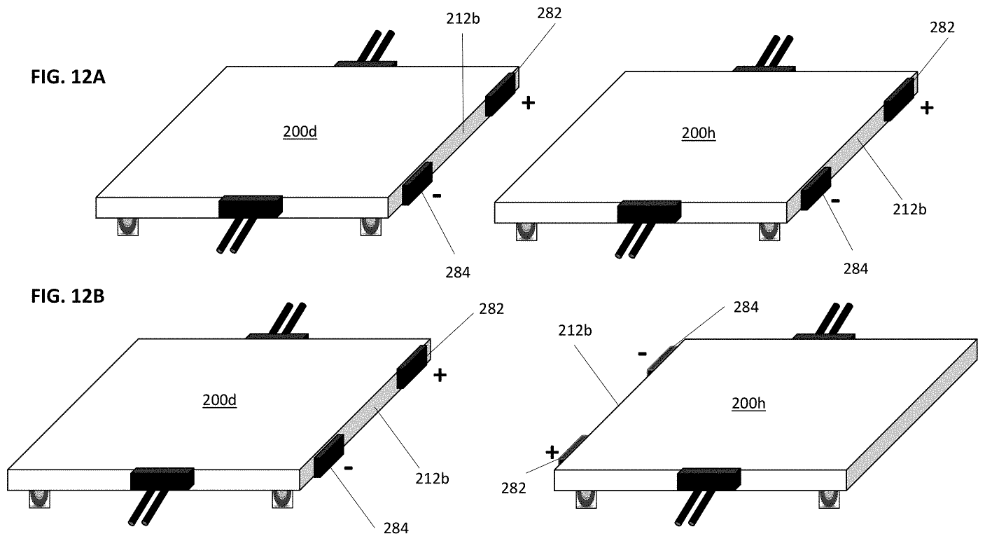

With reference to FIGS. 12A and 12B, in other embodiments, only one end, e.g., the trailing end 212b, of the body 210 of each transport robot 200h, 200d includes a pair of magnets 282, 284. In such embodiments, the healthy transport robot 200h is rotated and maneuvered into position such that the trailing end 212b of the body 210 thereof is positioned adjacent the trailing end 212b of the body 210 of the disabled transport robot 200d (see FIG. 12B). In this position, the magnet pairs 282, 284 and 284, 282 attract and engage one another, thereby coupling the transport robots 200h, 200d with one another to enable the healthy transport robot 200h to tow the disabled transport robot 200d.

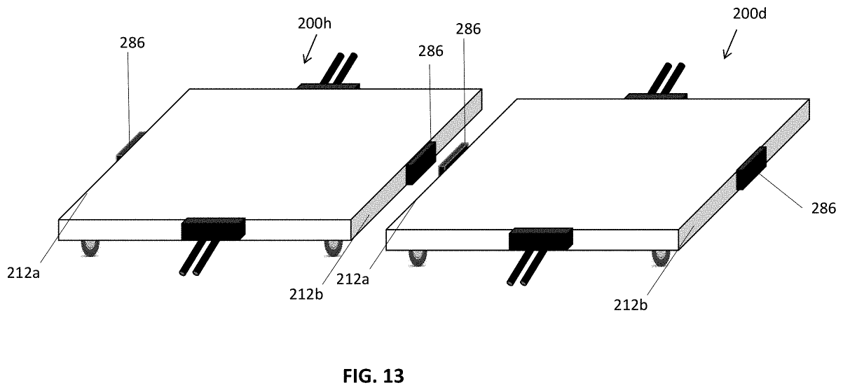

Turning to FIG. 13, in still other embodiments, rather than fixed-polarity magnets, each transport robot 200h, 200d may include an electromagnet 286 disposed at either or both of the leading or trailing ends 212a, 212b, respectively, of the body 210 thereof. In such configurations, depending upon the position and orientation of the transport robots 200h, 200d, the adjacent electromagnets 286 are charged to achieve opposite potentials to thereby exhibit opposite magnetic polarity such that the adjacent electromagnets 286 attract and engage one another, thereby coupling the transport robots 200h, 200d with one another to enable the healthy transport robot 200h to tow the disabled transport robot 200d.

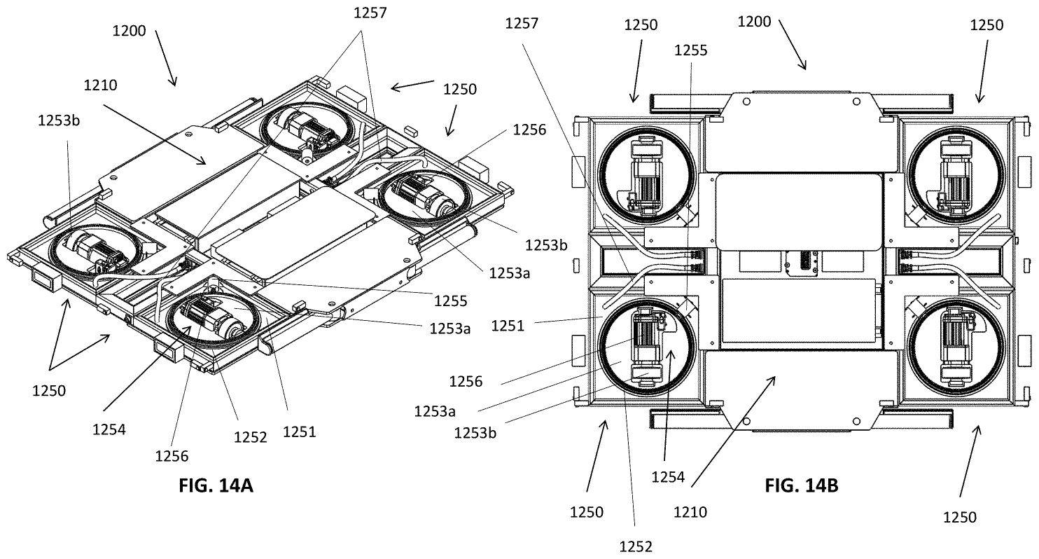

With reference to FIGS. 14A and 14B, another embodiment of a transport robot in accordance with the present disclosure is shown generally identified as transport robot 1200. Transport robot 1200 is similar to and may include any of the features of transport robot 200 (FIGS. 2-8), detailed above. Accordingly, only differences between transport robot 1200 and transport robot 200 (FIGS. 2-8) are described in detail below, while similarities are summarily described or omitted entirely.

Transport robot 1200 includes four powered drive sub-assemblies 1250 generally arranged such that each powered drive sub-assembly 1250 is positioned at one of the corners of transport robot 1200. Powered drive sub-assemblies 1250 are universal in that any powered drive sub-assembly 1250 may be positioned and releasably engaged at any corner of body 1210, are independently and collectively operable, and may be plug and play compatible, similarly as noted above with respect to powered drive sub-assemblies 250 of transport robot 200 (FIGS. 2-8). As with powered drive sub-assemblies 250 of transport robot 200 (see FIGS. 2-8), powered drive sub-assemblies 1250 of transport robot 1200 define a maximum vertical envelope of equal to or less than 4 inches, thus enabling transport robots 200, 1200 to freely maneuver within areas, e.g., underneath vehicles, having vertical clearances of as low as 4 inches (or lower).

Each powered drive sub-assembly 1250 includes a frame 1251, a wheel assembly 1254, a steering motor 1255, a drive motor 1256, and an electrical plug 1257 configured to connect to each powered drive sub-assembly 1250 to a corresponding electrical receptacle of body 1210 of transport robot 1200. Frame 1251 defines a circular opening 1252 including inwardly-facing gear thread disposed about the circumference of circular opening 1252, while a circular base 1253a of wheel assembly 1254 includes outwardly-facing gear thread disposed about the circumference of circular base 1253a. Circular base 1253a is rotatably disposed within circular opening 1252 of frame 1251 such that the gear threads of frame 1251 and circular base 1253a are meshed with one another. Steering motor 1255 is configured to drive rotation of circular base 1253a of wheel assembly 1254 relative to frame 1251 to a desired orientation to orient the wheel 1253b of wheel assembly 1254 in a desired orientation to enable steering of transport robot 1200. As can be appreciated, the meshed gear threads facilitate rotation to and retention of wheel assembly 1254 in a desired discrete orientation relative to frame 1251, although non-geared, continuous rotation configurations are also contemplated.

Continuing with reference to FIGS. 14A and 14B, wheel 1253b and drive motor 1256 of each powered drive sub-assembly 1250 are mounted on the corresponding circular base 1253a with drive motor 1256 operably coupled to wheel 1253b to drive rotation thereof to propel the transport robot 1200. More specifically, the output rotor of drive motor 1256 may be offset relative to and coupled to wheel 1253b via a drive belt such as illustrated with respect to transport robot 200 (FIGS. 2-8). Alternatively, as illustrated in FIGS. 14A and 14B with respect to transport robot 1200, the output rotor of drive motor 1256 may be in-line with wheel 1253b wherein the output rotor of drive motor 1256 is engaged with or defines the axle of wheel 1253b, e.g., with the output rotor and axle being coaxial with one another. Further, the co-axis defined by the output rotor and the axle is aligned on a diameter of circular base 1253a. As a result of this configuration, when steering motor 1255 is driven to rotate wheel assembly 1254 within and relative to frame 1251, wheel 1253b is rolled along the floor (or other support surface), or the rolling of wheel 1253b along the floor is increased (while the dragging thereof along the floor is decreased). This is advantageous in that it reduces wheel wear and friction as compared to non-aligned configurations wherein the wheel is dragged along the floor (or other support surface) or is dragged more and rolled less.

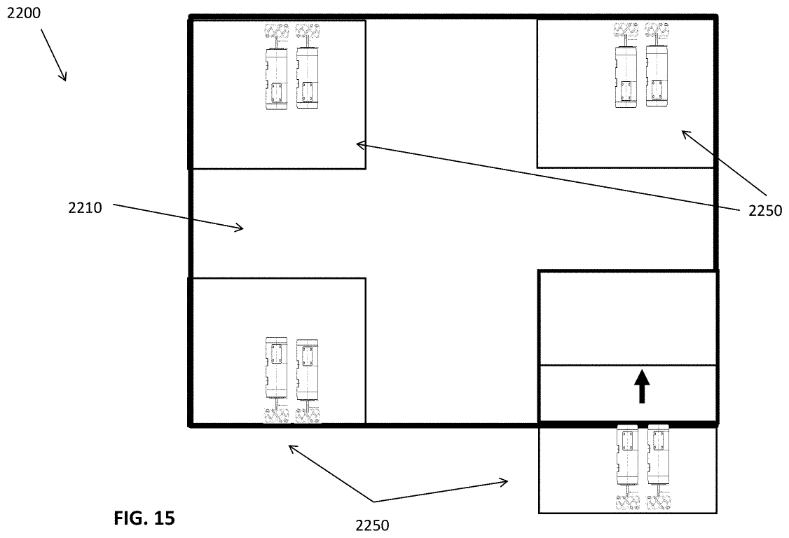

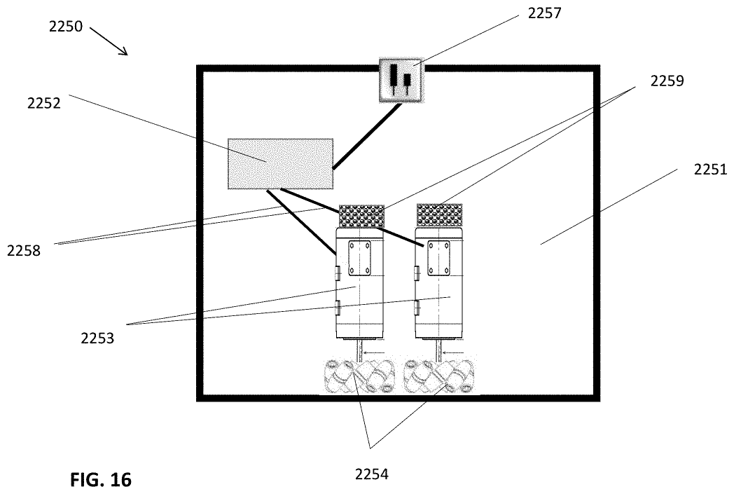

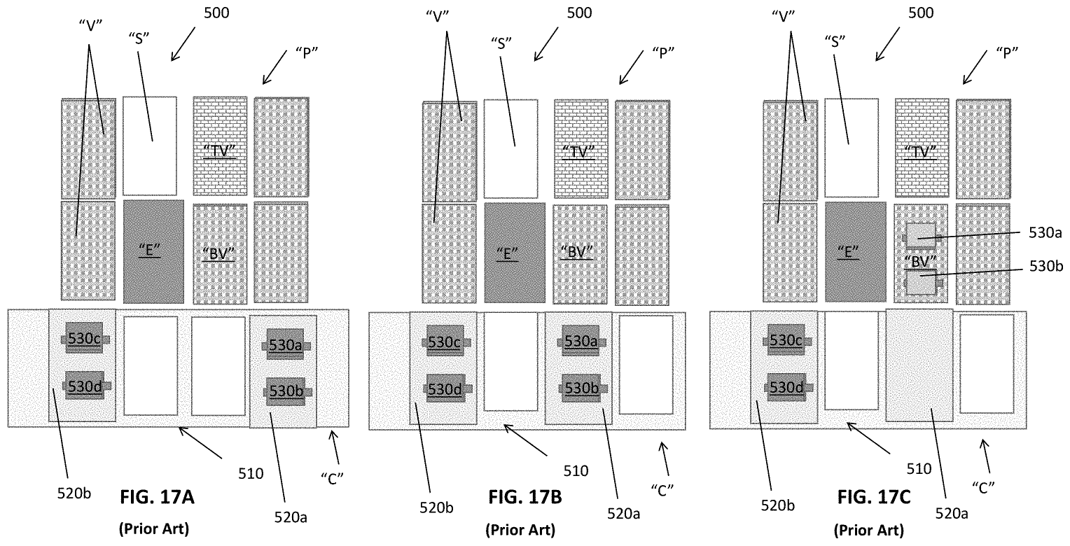

Turning to FIGS. 15 and 16, another embodiment of a transport robot in accordance with the present disclosure is shown generally identified as transport robot 2200. Transport robot 2200 is similar to and may include any of the features of transport robot 200 (FIGS. 2-8), detailed above. Accordingly, only differences between transport robot 2200 and transport robot 200 (FIGS. 2-8) are described in detail below, while similarities are summarily described or omitted entirely.

Transport robot 2200 includes four powered drive sub-assemblies 2250 generally arranged such that each powered drive sub-assembly 2250 is positioned at one of the corners of transport robot 2200. Powered drive sub-assemblies 2250 are universal in that any powered drive sub-assembly 2250 may be positioned and releasably engaged at any corner of body 2210, are independently and collectively operable, and may be plug and play compatible, similarly as noted above with respect to powered drive sub-assemblies 250 of transport robot 200 (FIGS. 2-8). As with powered drive sub-assemblies 250 of transport robot 200 (see FIGS. 2-8), powered drive sub-assemblies 2250 of transport robot 2200 define a maximum vertical envelope of equal to or less than 4 inches, thus enabling transport robot 2200 to freely maneuver within areas, e.g., underneath vehicles, having vertical clearances of as low as 4 inches (or lower).

Each powered drive sub-assembly 2250 includes a frame 2251, a motor controller 2252, a pair of drive motors 2253, and a pair of omnidirectional wheels, e.g., Mecanum wheels 2254, although one wheel or more than two wheels, e.g., three wheels, are also contemplated. Providing two drive motors 2253 each configured to drive a Mecanum wheels 2254 increases the motive force, adding power and velocity, while the side-by-side configuration thereof maintains the vertical clearance of transport robot 2250 of 4 inches (or lower). This configuration, in embodiments, may provide an unloaded velocity of transport robot 2250 of up to 10 feet per second and a located velocity of up to 5 feet per second.

In order to drive transport robot 2200 in a particular direction, the driven directions of the pairs of Mecanum wheels 2254 of the powered drive sub-assemblies 2250 are selected accordingly. For example, in order to translate transport robot 2200 in a first direction, all four pairs of Mecanum wheels 2254 are driven in a forward direction. In order to translate transport robot 2200 in a second, opposite direction, all four pairs of Mecanum wheels 2254 are driven in a reverse direction. In order to translate transport robot 2200 in a third direction perpendicular to the first and second directions, one set of diagonally-opposed pairs of Mecanum wheels 2254 is driven in the forward direction while the other set of diagonally-opposed pairs of Mecanum wheels 2254 is driven in the reverse direction. To translate transport robot 2200 in a fourth direction perpendicular to the first and second directions and opposite the third direction, the one set of diagonally-opposed pairs of Mecanum wheels 2254 is driven in the reverse direction while the other set of diagonally-opposed pairs of Mecanum wheels 2254 is driven in the forward direction.

The above-detailed double motor and wheel configuration, while increasing speed, also increasers vibrations significantly. As such, each powered drive sub-assembly 2250 further includes a non-linear spring-based suspension, e.g., including a non-linear antivibration spring 2259 (in embodiments, a tunable non-linear antivibration spring; in embodiments, multiple springs), operably coupling each of the drive motors 2253 and Mecanum wheels 2254 to the frame 2251. This configuration reduces vibrations from the operation of Mecanum wheels 2254 without requiring an increase in the overall vertical clearance of the transport robot 2200.

Power and data cables 2258 connect motor controller 2252 with each of the drive motors 2253, while another cable connects motor controls 2252 with electrical plug 2257 which, in turn, is configured to connect to the powered drive sub-assembly 2250 to a corresponding electrical receptacle of body 2210 of transport robot 2200. Other electrical powering and/or communication configurations are also contemplated.

The above-detailed embodiments of transport robots are capable of moving freely underneath vehicles in a 4 inch vertical clearance envelope. This feature contributes to the cooperative maneuvering, or swarming, of plural robots in a system, e.g., in a parking facility to achieve one or more tasks, examples of which are detailed below. The transport robots and systems of the present disclosure enable use in a parking facility for parking vehicles or for other purposes and/or in other locations without relying on the use of pallets, e.g., without the need for placing vehicles on pallets to enable the transport and maneuvering thereof. Pallet-based solutions not only require pallets but also require development of mechanically intensive pallet logistical devices. The pallets must themselves be transported and stored such that pallets are always located at the point(s) of entry, e.g., the entrance to the parking facility, to receive vehicles thereof. Of note, the real-estate in and around the points of entry is often the most operationally valuable real-estate in a parking facility and is often a choke point that controls the rate of ingress and exit from the facility. The pallet logistical equipment often represents a single point of failure or choke point wherein logical system failures can severely disrupt or halt operations.

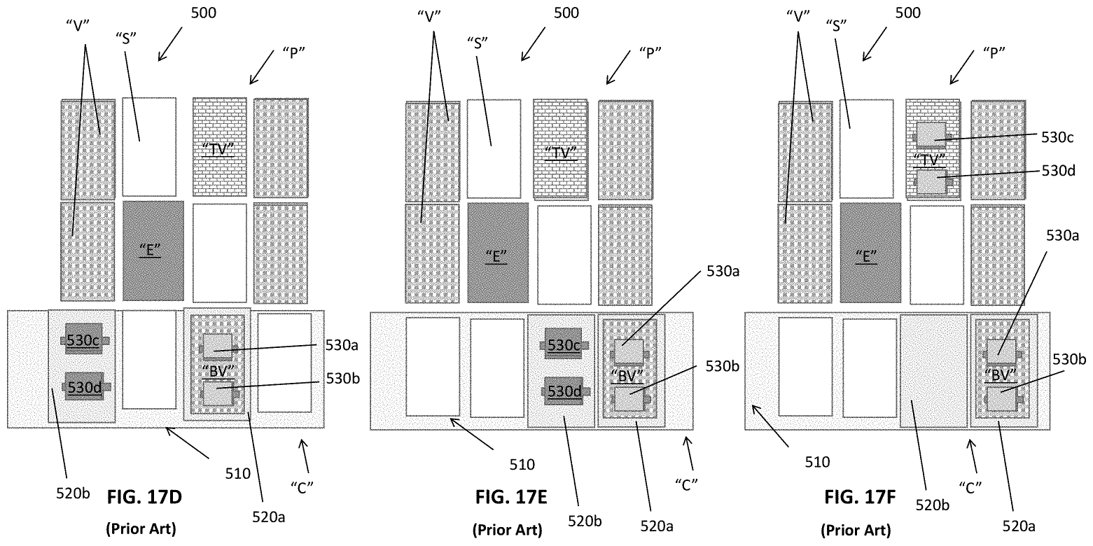

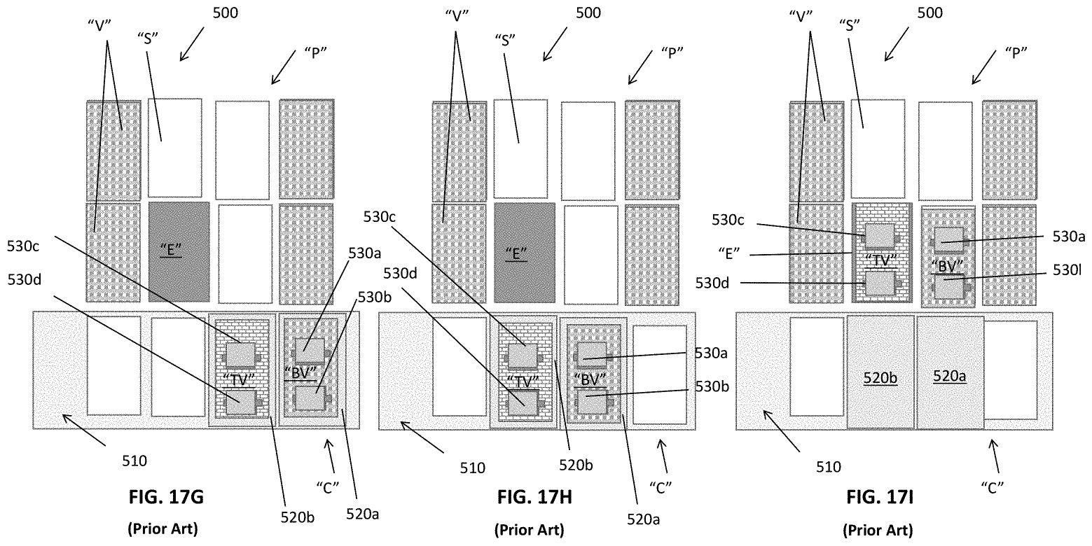

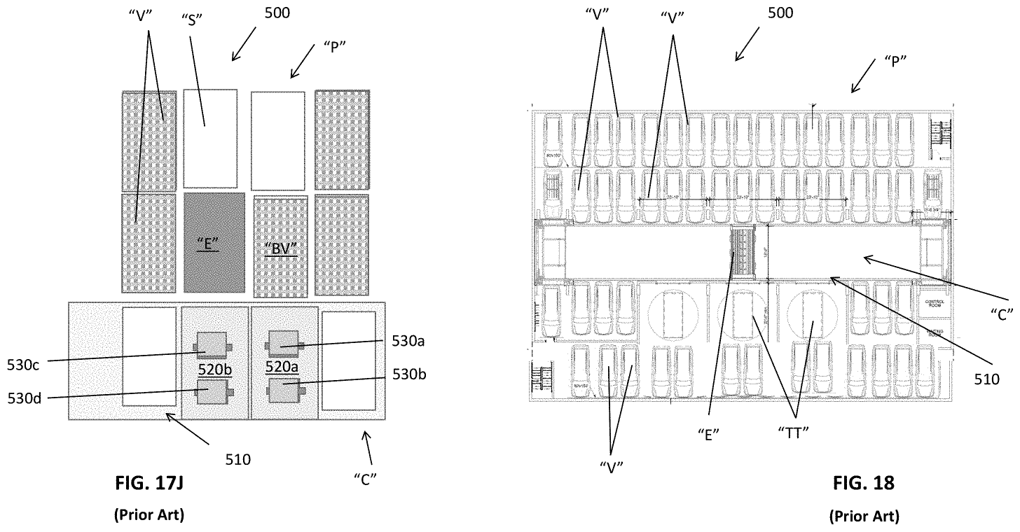

Referring to FIGS. 17A-17J, a prior art automated parking system operating in a parking structure “P” including a canyon “C,” one or more elevators “E,” and a plurality of parking stalls “S” including vehicles “V” is shown generally identified as system 500. System 500 includes a set of tracks or rails 510 extending along the canyon “C;” one or more transfer carts 520a, 520b configured to move through the canyon “C” along the tracks or rails 510 in a single direction, e.g., the “X” direction; and a plurality of robotic carts 530a-530d configured to be transported on transfer carts 520a, 520b to a desired location in the “X” direction and to move in a different single direction, e.g., the “Y” direction, off the transfer carts 520a, 520b to retrieve or drop off vehicles “V” and subsequently return in the “Y” direction to the transfer carts 530a-530d.

Starting with FIGS. 17A and 17B, in order to retrieve a target vehicle “TV” from among the plurality of vehicles “V” utilizing prior art automated parking system 500, transfer cart 520a, carrying robotic carts 530a, 530b, is moved along tracks or rails 510 in the “X” direction until transfer cart 520a is aligned, in the “Y” direction, with a blocking vehicle “BV” blocking a path for the target vehicle “TV.”

Continuing to FIGS. 17C and 17D, with transfer cart 520a aligned with the blocking vehicle “BV,” robotic carts 530a, 530b are deployed from transfer cart 520a and move in the “Y” direction to retrieve the blocking vehicle “BV” and return with the blocking vehicle “BV” to transfer cart 520a.

Referring to FIGS. 17E-17G, once robotic carts 530a, 530b, carrying the blocking vehicle “BV,” are returned to transfer cart 520a, transfer cart 520a are moved along tracks or rails 510 in the “X” direction to displace transfer cart 520a, robotic carts 530a, 530b, and the blocking vehicle “BV” in the “Y” direction relative to the target vehicle “TV.” With transfer cart 520a, robotic carts 530a, 530b, and the blocking vehicle “BV” so displaced, transfer cart 520b, carrying robotic carts 530c, 530d, is moved along tracks or rails 510 in the “X” direction until transfer cart 520b is aligned, in the “Y” direction, with the target vehicle “TV.” Thereafter, robotic carts 530c, 530d are deployed from transfer cart 520b and move in the “Y” direction to retrieve the target vehicle “TV” and return with the target vehicle “TV” to transfer cart 520b.

As illustrated in FIGS. 17H-17J, with robotic carts 530c, 530d, carrying the target vehicle “TV,” having returned to transfer cart 520b, transfer cart 520b is moved along tracks or rails 510 in the “X” direction until transfer cart 520b is aligned, in the “Y” direction, with the elevator “E,” thus allowing robotic carts 530c, 530d to drive off transfer cart 520b, in the “Y” direction, onto the elevator “E” for transport to the drop-off location. If required, robotic carts 530c, 530d may first drive off transfer cart 520b, in the “Y” direction, onto a turntable “TT” (see FIG. 2) to reorient the target vehicle “TV” in a drop-off orientation before moving in the “Y” direction onto the elevator “E” for transport to the drop-off location.

Thereafter or simultaneously therewith, transfer cart 520a is moved along tracks or rails 510 in the “X” direction until transfer cart 520a is once again aligned with the parking stall “S” previously occupied by the blocking vehicle “BV,” thus allowing robotic carts 530a 530b to move in the “Y” direction to return the blocking vehicle “BV” to its initial position.

Referring to FIG. 18, prior art automated parking system 500 is illustrated requiring space for canyon “C” and turntables “TT.” As can be appreciated, this required space is not available as space that can be used for parking stalls “S” and, thus, reduces the number of vehicles “V” capable of being parked in parking structure “P.” More specifically, utilizing automated parking system 500, parking structure “P” includes 53 parking stalls “S” available.

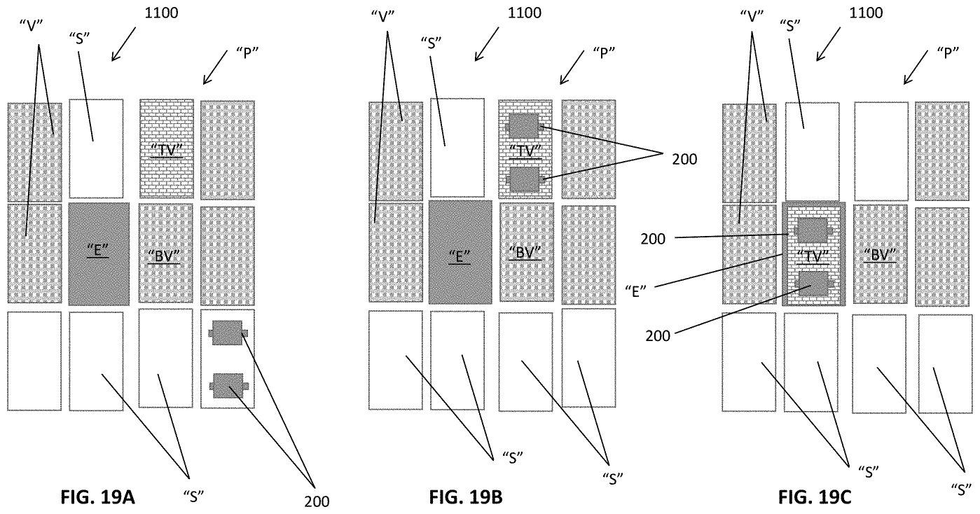

Turning to FIGS. 19A-19C, an automated parking system provided in accordance with the present disclosure is shown generally identified by reference numeral 1100 operating in parking structure “P” including one or more elevators “E,” and a plurality of parking stalls “S” including vehicles “V.” With momentary additional reference to FIG. 18, in contrast to prior art automated parking system 500, automated parking system 1100 of the present disclosure does not require tracks or rails 510, transfer carts 520a, 520b, turntables “TT,” or canyon “C.”

Continuing with reference to FIGS. 19A-19C, automated parking system 1100 includes a plurality of transport robots 200, e.g., transport robots 200 as detailed above, any other transport robots detailed herein, or any other suitable transport robot(s) or combinations thereof. As detailed above, each transport robot 200 is capable of moving in any direction, e.g., any direction vector having any “X” component and/or any “Y” component, and is further capable of rotation about a “Z” axis with a zero or minimal turning radius. Thus, as demonstrated below, automated parking system 1100 enables retrieval of the same target vehicle “TV” from a parking structure “P” having the same arrangement of vehicles “V” (including blocking vehicle “BV”) as detailed above with respect to prior art automated parking system 500 (see FIGS. 17A-18), and does so only requiring two transport robots 200 with a greatly reduced number of maneuvers.

In order to retrieve target vehicle “TV” from among the plurality of vehicles “V” utilizing automated parking system 1100, as illustrated in FIGS. 19A-19C, transport robots 200 are first moved in the “X” direction into alignment, in the “Y” direction, with the target vehicle “TV,” and then are moved in the “Y” direction, traversing underneath the blocking vehicle “BV” to the target vehicle “TV, wherein transport robots 200 are positioned underneath and engaged with the target vehicle “TV” to enable transport thereof. With the target vehicle “TV” engaged by the transport robots 200, the transport robots 200 are moved in the “X” direction, carrying the target vehicle “TV thereto, to an adjacent empty stall “S” and, from there, in the “Y” direction onto the elevator “E” for transport to the drop-off location. If required, transport robots 200 may be rotated to reorient the target vehicle “TV” in a drop-off orientation before or after moving onto the elevator “E” for transport to the drop-off location.

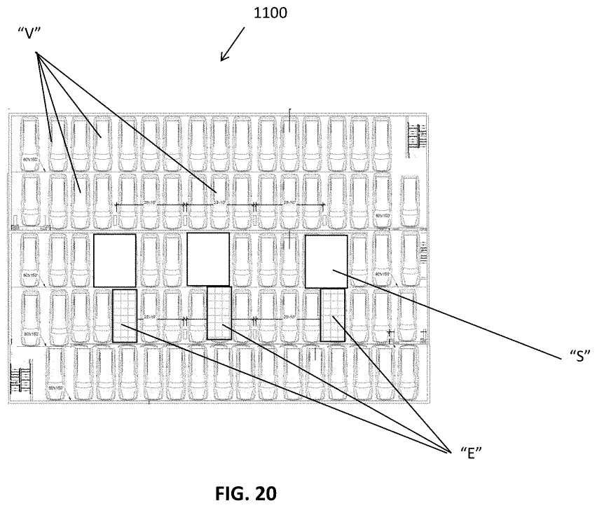

Referring also to FIG. 20, automated parking system 1100 is illustrated requiring minimal empty stalls “S” to permit maneuverability of vehicles “V” to retrieve a target vehicle. More specifically, comparing automated parking system 1100, as shown in FIG. 20, with prior art automated parking system 500, as shown in FIG. 18, it can be seen that using the same parking structure “P,” the number of available spaces and, thus, the number of vehicles “V” capable of being parked, is significantly greater for system 1100 as compared to system 500. More specifically, utilizing automated parking system 1100, parking structure “P” includes 74 parking stalls “S” available. In addition, as noted above, the need for tracks or rails, transfer carts, turntables, or canyons are eliminated. Although only a single floor or parking structure “P” is illustrated, it is understood that automated parking system 1100 may operate across any number of floors, structural configurations, non-structural limitations, etc., of a parking structure “P.”

Turning back to FIGS. 1A-1C, in conjunction with FIGS. 19A-19C, automated parking system 1100 (FIGS. 19A-19C), in addition to the plurality of transport robots 200 (which may be identical to one another or different from one another), includes central control system 160. Although detailed above with respect to system 100 (FIGS. 1A-1C), certain features of central control system 160 are repeated and/or expanded upon here in the context of automated parking system 1100 (FIGS. 19A-19C); however, it is understood that, whether incorporated into system 100 (FIGS. 1A-1C), system 1100 (FIGS. 19A-19C), or any other suitable system, central control system 160 may include any of the aspects and/or features detailed herein.

Central control system 160 is configured to communicate with one or more of transport robots 200, directly or indirectly, to coordinate performance of desired tasks, e.g., drop off one or more vehicles, retrieve one or more vehicles, and/or performance of other operations, e.g., to perform a housekeeping operation, direct one or more transport robots 200 to a maintenance station, direct one or more transport robots 200 to a charging station, activate one or more transport robots 200, deactivate one or more transport robots 200, etc. With respect to a particular task or operation, central control system 160 directs transport robots 200 where to go, what actions to take, route planning, re-planning, and all other higher level decisions, while the onboard controls, e.g., CPU sub-assemblies 230 (FIG. 2), of transport robots 200 enable transport robots 200 themselves and/or as groups of two or more transport robots 200, to determine how to take the desired actions, how to move/rotate, coordinate with other transport robot 200, position relative to a vehicle, engage and lift a vehicle, avoid collisions, and other local decisions. That is, one or more of the transport robots 200 has local control to carry out a particular task, while central control system 160 retains supervisory control to direct the tasks to be performed and aid transport robots 200 with localization, route planning, etc. In addition, central control system 160 may communicate information to transport robots 200 relating to, for example, positioning, updating, collision avoidance, docking/charging, maintenance, and logging of data, errors, near-miss events, etc. Supervisory control of the transport robots 200 by central control system 160 may also include overriding capability such as, for example, with respect to collision avoidance. Although collision avoidance is in part accomplished by the transport robots 200 at the local level, e.g., via the on-board sensors on transport robots 200 indicating the presence of another transport robot 200 or other obstacle and/or local rules governing transport robots 200, central control system 160 may intervene to provide control based upon new or updated priorities and, as a result, slow or stop the lower-priority transport robot(s) 200 to allow the higher priority transport robot(s) 200 to pass first.

Central control system 160 is further configured, for each transport robot 200 and/or the system 1100 as a whole, to track: the location, diagnostics, and other information from each transport robot 200, performance history, maintenance history and cycles, payment systems, performance metrics, emergency services, security systems, etc. Central control system 160 is also configured to maintain input and expected output times for each vehicle and account for the same in determining where and how to park the vehicles. Additional information input to central control system 160 that may be used in determining where and how to park the vehicles includes, for example, whether or not the vehicle is a ride share or rental vehicle, an electric vehicle, requests additional services (electric vehicle charging, car washing, oil and lubrication services, interior cleaning, etc.); whether the vehicle is a commercial vehicle, driverless car, special vehicle (e.g., an oversize vehicle, handicap-accessible vehicle, panel trucks, etc.); etc.

Referring to FIG. 1A, in embodiments, transport robots 200 may cooperate in pairs wherein one of the transport robots 200 directly communicates with central control system 160 and, based upon communicates therewith, directs the other transport robot 200 of the pair accordingly, although the follower transport robot 200 in each pair may likewise be configured to communicate directly with central control system 160 as well. The transport robots 200, in embodiments, are identical in hardware, but are configurable (and reconfigurable) via central control system 160 (or other control) to operate in separate capacities. Multiple pairs of transport robots 200 may be provided. With respect to each pair of transport robots 200, the lead transport robot 200 is responsible for decision making, e.g., local command and control functions, for both transport robots 200 as well as communication with other transport robots 200 and/or central control system 160. However, if the lead transport robot 200 fails, the lead role may be reversed. Central control system 160 may also reassign the lead role or assign a different configuration of a pair or group of transport robots 200. For example, the lead/follow assignments of one or more transport robots 200 may be changed in whole or in part via central control system 160 to exploit internal redundancy, thus helping to overcome and/or contain the effects of malfunctions of certain subsystem, e.g., malfunction of navigation of one transport robot 200 can be accounted for by transitioning the lead role for the limited purpose of navigation from the malfunctioned transport robot 200 to another transport robot 200 with healthy navigation. In this way, failed components, sub-systems, sensors, etc., can be readily overcome by the redundancy of multiple transport robots 200, e.g., pairs of transport robots 200, working as a team. Such applies equally to other critical functions including but not limited to off-board communications, collision avoidance, critical on-board maneuver controls, reroute planning and execution, etc.

With reference to FIG. 1B, in other embodiments, one of the transport robots 200 directly communicates with central control system 160 and, based upon communications therewith, directs a plurality of other transport robots 200 accordingly. Multiple “lead” transport robots 200 each directing a plurality of other transport robots 200 may be provided.

As shown in FIG. 1C, in still other embodiments, each transport robot 200 may communicate directly with central control system 160. Combinations of the above configurations illustrated in FIGS. 1A-1C or other suitable configurations are also contemplated.

Referring generally to FIGS. 1A-1C, regardless of the particular communication configuration between transport robots 200 and central control system 160, central control system 160 and/or transport robots 200 communicate such that transport robots 200 work in cooperation, e.g., via plural coordinate maneuvers performed consecutively, simultaneously, or in overlapping temporal relation, with one another to perform tasks. Further, the particular roles, communication configuration, etc. may be modified during use to provide real-time optimization based upon new circumstances or other reasons. In embodiments, redundant local communications to and from all transport robots 200 and/or to and from central control system 160 are provided, e.g., via WiFi or other suitable communications protocols. Each of the transport robots 200, or at least the lead transport robot(s) 200 may periodically, continuously, and/or after each maneuver, store the overall configuration of the parking structure and vehicles therein such that, in the event of communication failure, failure of the central control system 160, or other failure, the transport robots 200 can at least perform minimum necessary operational tasks such as, for example, emptying the parking structure.

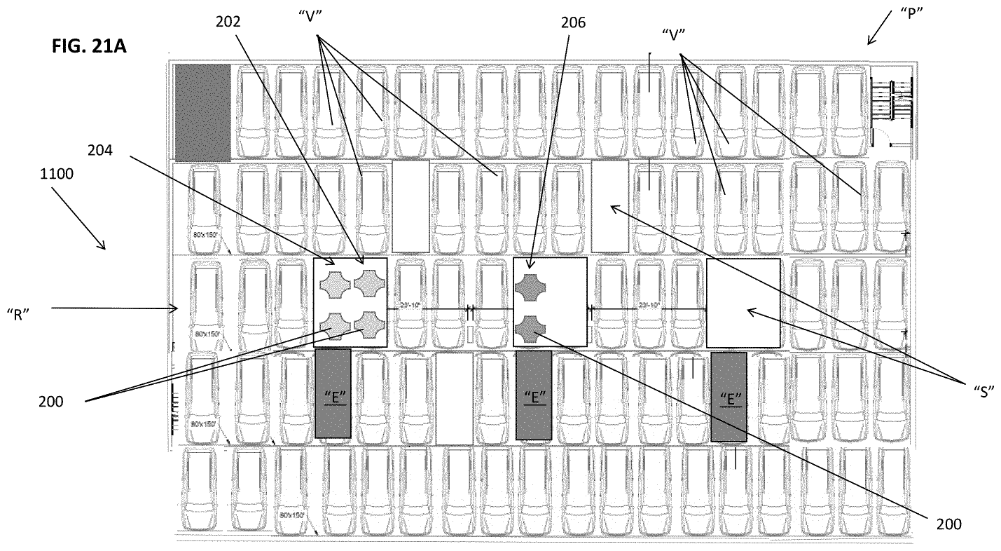

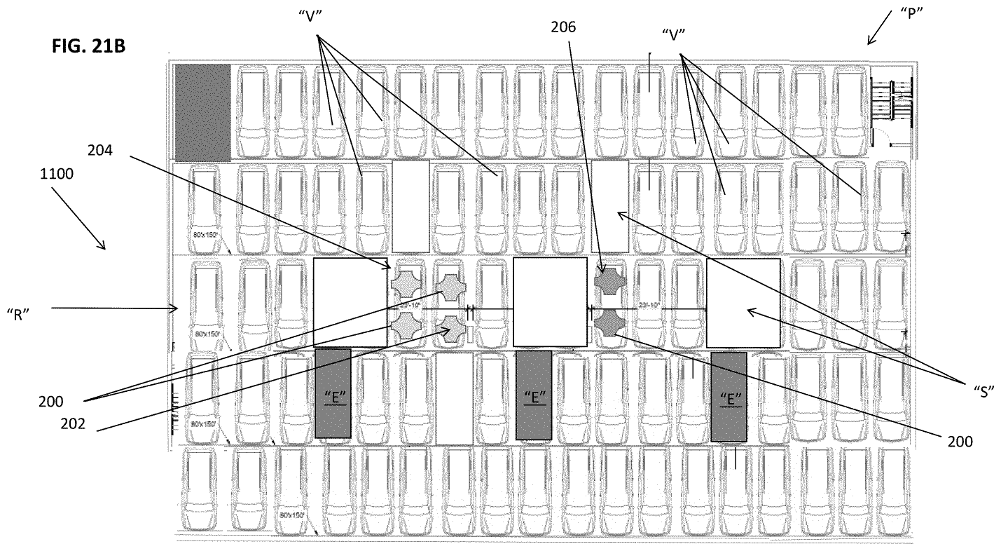

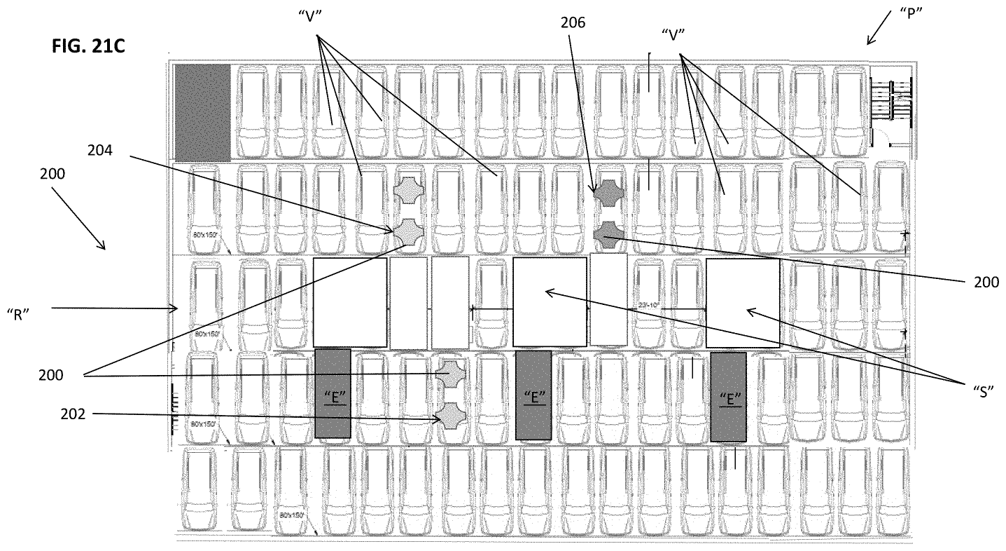

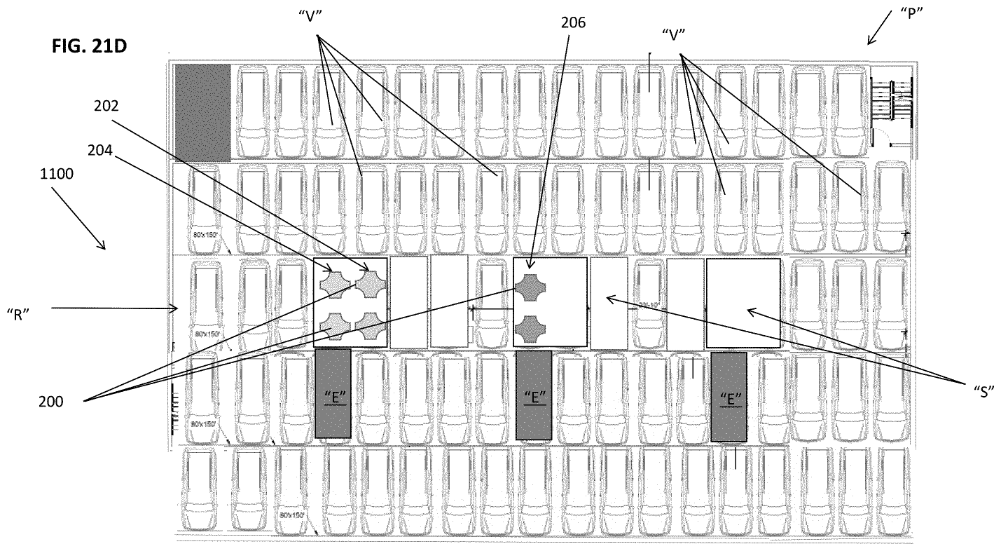

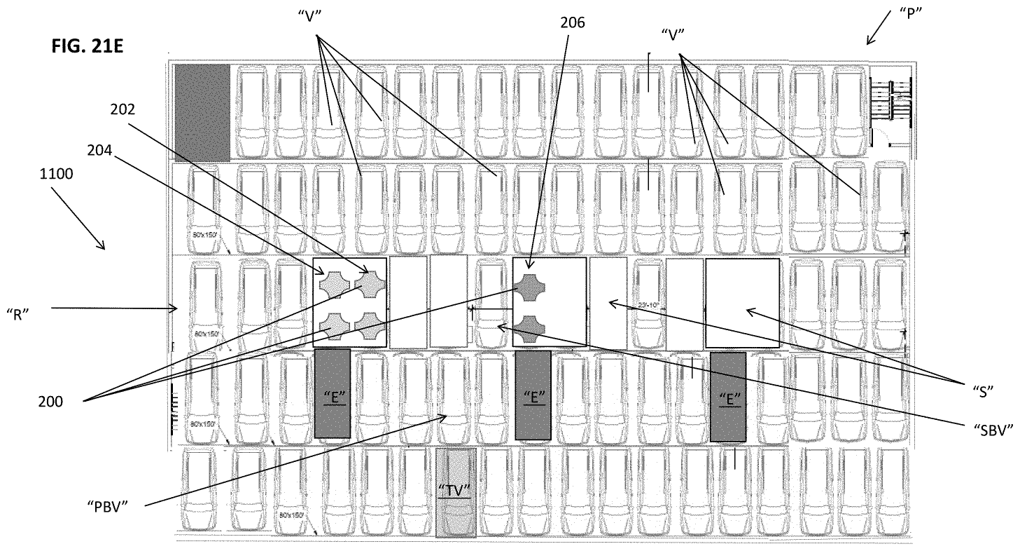

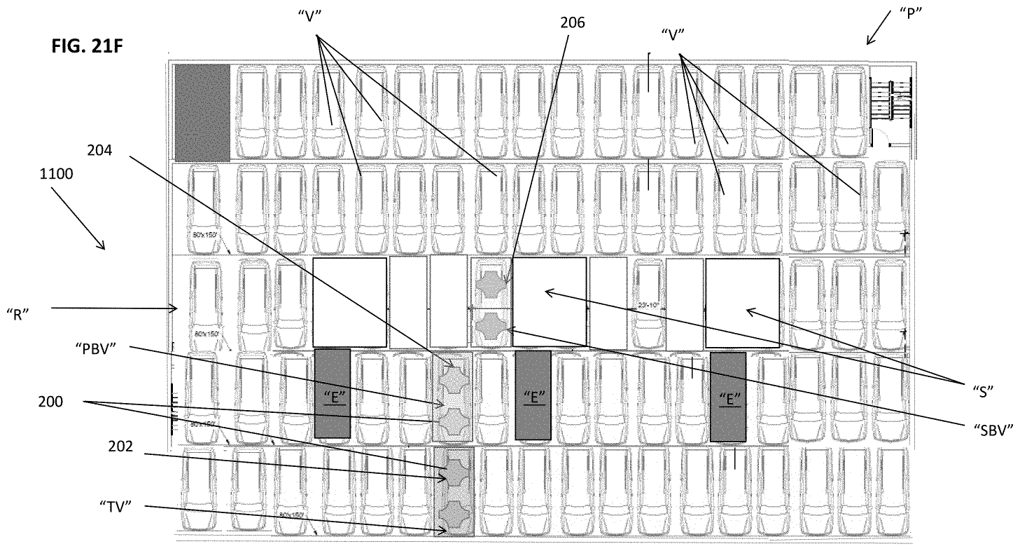

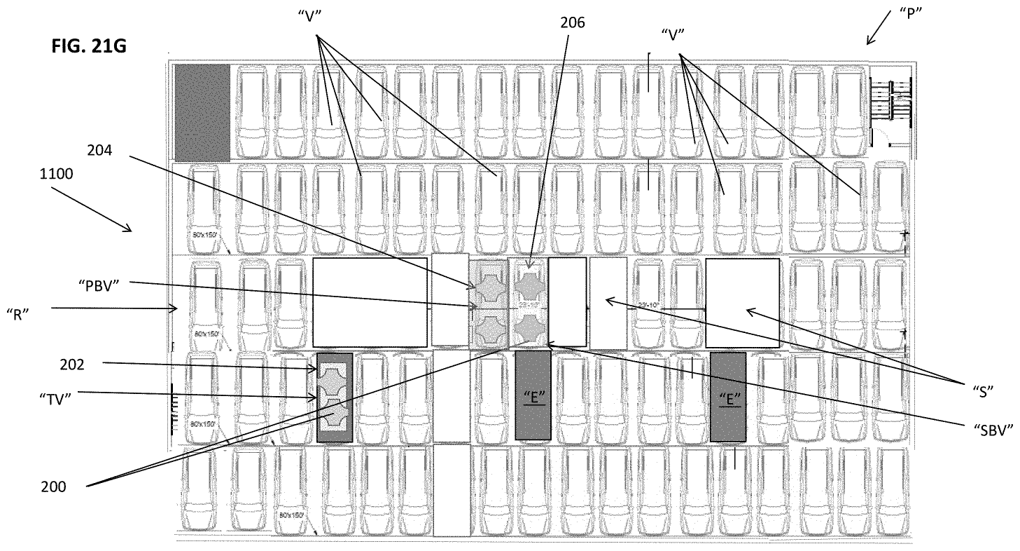

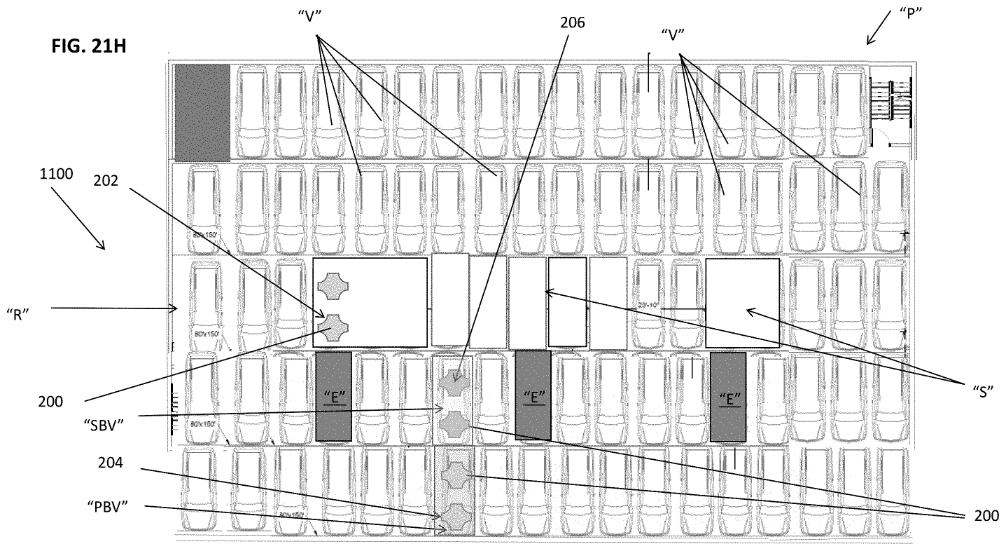

Referring momentarily to FIGS. 20 and 21A, in embodiments, automated parking system 1100 provides a ratio of pairs of transport robots 200 to parking stalls per floor of up to 1:5; in other embodiments, up to 1:15; in yet other embodiments, up to 1:25; and in still other embodiments, up to 1:40. Additionally or alternatively, in embodiments, automated parking system 1100 provides, in embodiments, a ratio of elevators “E” to pairs of transport robots 200 per floor of up to 1:10; in other embodiments, up to 1:20; and in still other embodiments, up to 1:30.

Turning to FIGS. 21A-21D, use of automated parking system 1100 to perform a housekeeping operation, e.g., during idle time, to facilitate efficient retrieval of any vehicle “V” upon a subsequent request, is illustrated. First, second, and third pairs 202, 204, 206 of transport robots 200 are provided; however, it is understood that greater or fewer pairs may also be provided. As illustrated in FIG. 221, empty stalls “S” are randomly located throughout the parking structure “P” and amongst the parked vehicles “V,” e.g., as a result of a previous retrieval or drop off. In order to maximize efficiency, the housekeeping operation may be performed to relocate the positions of the empty stalls “S” for a subsequent retrieval of any vehicle “V” with minimal time and/or maneuvers.

Referring also to FIGS. 21B-21D, to perform the housekeeping operation, the pairs 202, 204, 206 of transport robots 200 are operated to move vehicles “V” as necessary such that empty stalls “S” are located along a central row “R” of the parking structure “P” and such that at least one empty stall “S” is directly adjacent, e.g., directly forward, behind, left, or right of, each elevator “E.” In embodiments, the housekeeping operation is effected such that an additional empty stall “E” is located along the central row “R” directly adjacent each of the above-mentioned empty stalls “S,” e.g., those that are directly adjacent an elevator “E.”

Turning to FIGS. 21E-21G, use of the pairs 202, 204, 206 of transport robots 200 in order to retrieve a vehicle, for example, target vehicle “TV,” is described, starting from the housekeeping configuration detailed above. Initially, with reference to FIGS. 21E and 21F, first pair 202 of transport robots 200 is moved first in the “X” direction and then in the “Y” direction to be positioned underneath the target vehicle “TV;” second pair 204 of transport robots 200 is moved first in the “X” direction and then in the “Y” direction to be positioned underneath a primary blocking vehicle “PBV;” and third pair 206 of transport robots 200 is moved in the “X” direction to be positioned underneath a secondary blocking vehicle “SBV.” The above-noted actions of the pairs 202, 204, 206 of transport robots 200 may be effected simultaneously or near-simultaneously with one another and result in the arrangement illustrated in FIG. 21F.

With reference to FIG. 21G, once the pairs 202, 204, 206 of transport robots 200 are arranged as noted above, each pair 202, 204, 206 of transport robots 200 may be engaged with the respective vehicle “TV,” “PBV,” “SBV” thereabove to enable transport of the respective vehicles “TV,” “PBV,” “SBV.” More specifically, each pair 202, 204, 206 of transport robots 200 transports the respective vehicle “TV,” “PBV,” “SBV” engaged therewith such that the secondary blocking vehicle “SBV” is moved to enable the primary blocking vehicle “PBV” to be moved to the stall “S” vacated by the secondary blocking vehicle “SBV,” thereby defining a path of empty stalls “S” (wherein each empty stall “S” in the path is connected to adjacent empty stall(s) “S” in side-by-side or end-to-end relation), thus allowing the target vehicle “TV” to be transported therealong to the elevator “E,” as illustrated in FIG. 21G.

Referring to FIGS. 21H and 211, once the target vehicle “TV” (FIG. 21G) is removed, a further housekeeping operation is performed wherein the primary blocking vehicle “PBV” is moved to the stall “S” initially occupied by the target vehicle “TV” (FIG. 21G) and the secondary blocking vehicle “SBV” is moved to the stall “S” initially occupied by the primary blocking vehicle “PBV.” Thereafter, the pairs 202, 206 of transport robots 200 are disengaged from the primary blocking vehicle “PBV” and the secondary blocking vehicle “SBV,” respectively, and returned to the central row “R” to await further instructions.

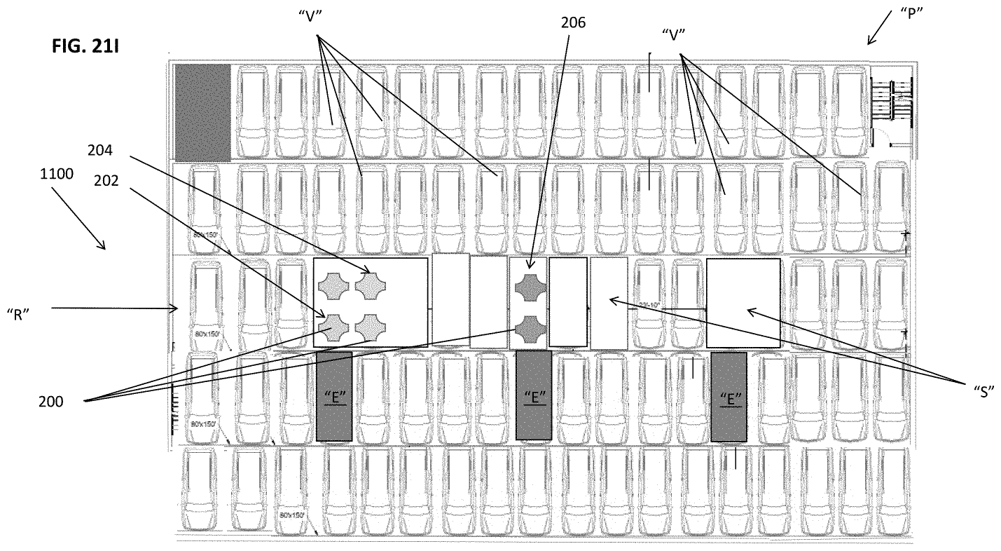

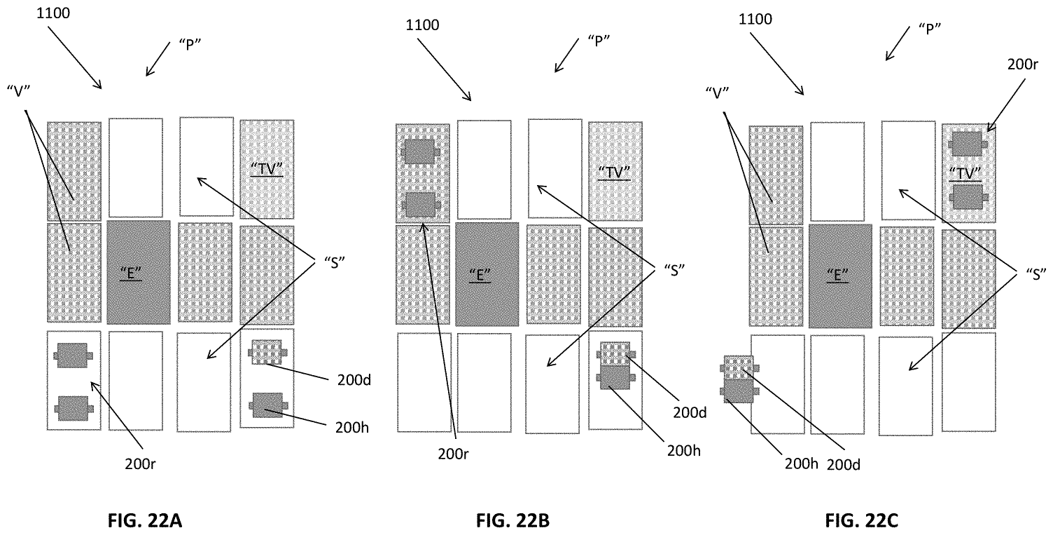

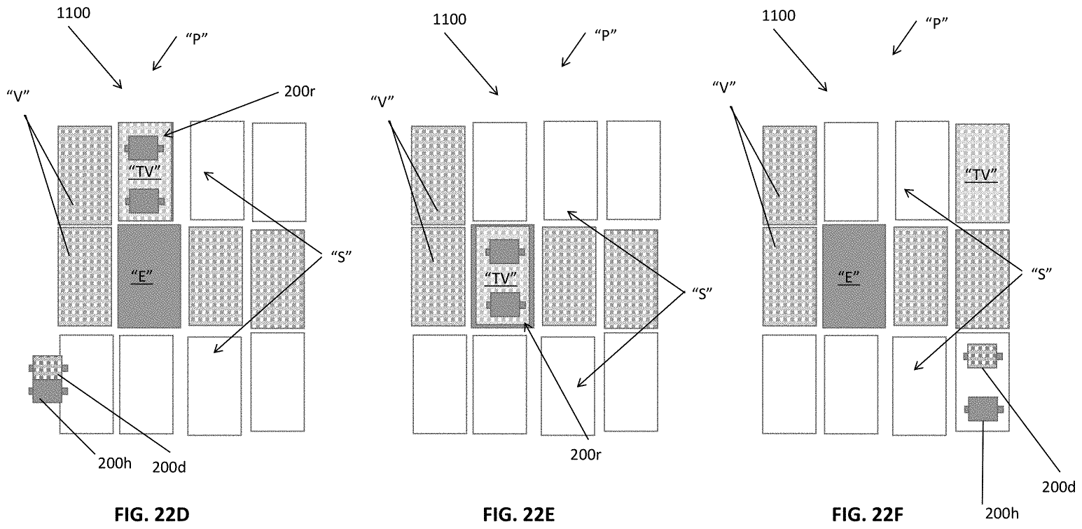

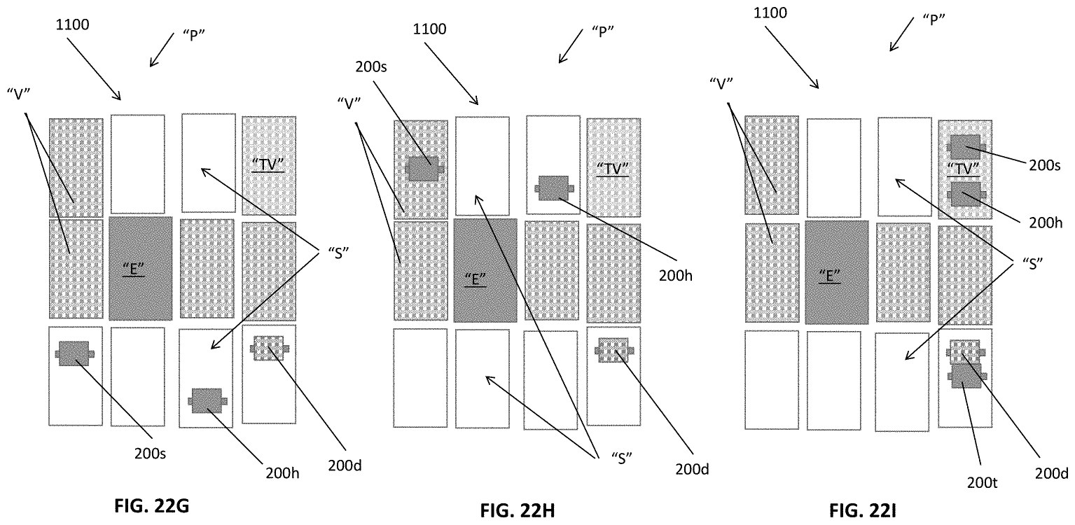

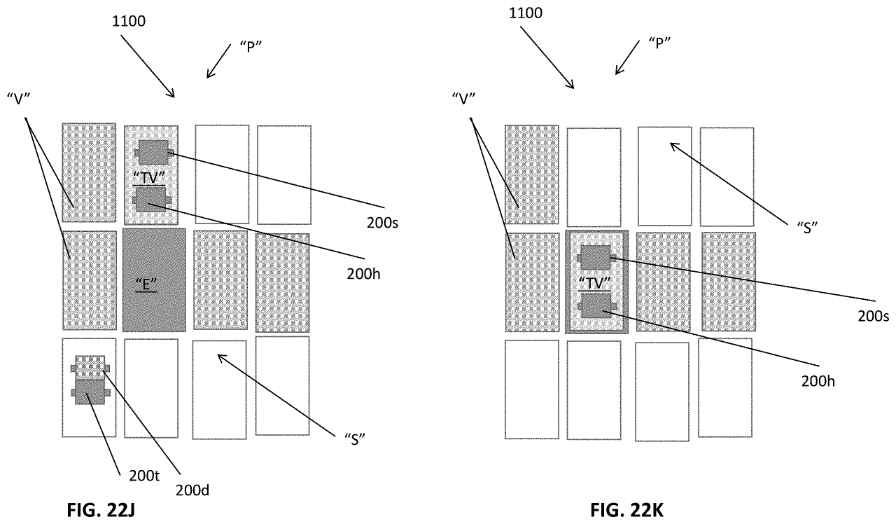

Turning to FIGS. 22A-22E, removal of and compensation for a disabled transport robot 200d is detailed. More specifically, when a disabled transport robot 200d of a transport robot pair is detected, the healthy robot 200h in the pair engages the disabled transport robot 200d and tows the disabled transport robot 200d out of the way, e.g., to a repair station. Meanwhile, a healthy pair of replacement transport robots 200r is utilized to retrieve the target vehicle “TV” and bring the target vehicle “TV” to the elevator “E.” In this manner, the disabled transport robot 200d is removed while the task of retrieving the target vehicle “TV” is still accomplished using replacement transport robots 200r.

As an alternative to the removal of and compensation for the disabled transport robot 200d as detailed above, FIGS. 22F-22K illustrate the isolation and subsequent removal of disabled transport robot 200d, and compensation therefor, in accordance with other embodiments. More specifically, when a disabled transport robot 200d of a transport robot pair is detected, the healthy robot 200h in the pair leaves the disabled transport robot 200d and joins with a healthy substitute transport robot 200s to form a fully health pair that is utilized to retrieve the target vehicle “TV” and bring the target vehicle “TV” to the elevator “E.” Meanwhile, a tow transport robot 200t is utilized to retrieve the disabled transport robot 200d and tow the disabled transport robot 200d to a repair station. In this manner, the disabled transport robot 200d is isolated and subsequently removed while the task of retrieving the target vehicle “TV” is still accomplished.

Referring generally to FIGS. 22A-22K, the above detailed embodiments are examples of how transport robots 200 may work individually, in pairs, and/or as part of a broader system to accomplish a task and overcome adversity. Generally, transport robots 200 operate to work as a group of two or more transport robots 200 (within which, sub-groups or pairs of transport robots 200 may be provided) to accomplish tasks and self-heal as needed.

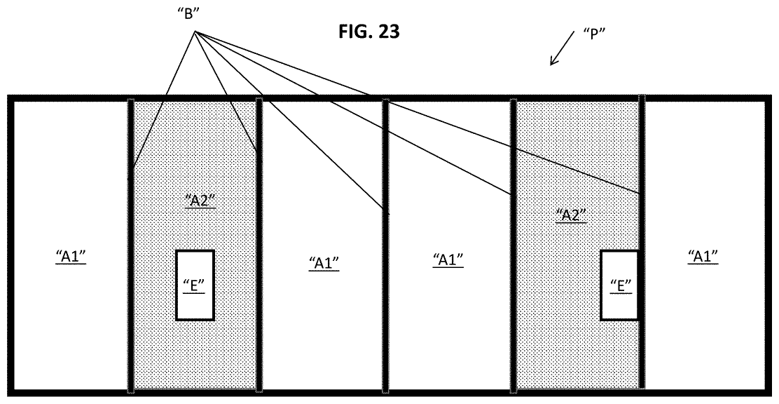

Turning to FIG. 23, a floor layout of a portion of parking structure “P” is illustrated including two elevators “E” and a plurality of lower-clearance beams or other obstructions “B” as is typical in a parking structure “P.” Parking structure “P” includes standard parking areas “A1” that require vehicles to travel under one or more of beams “B” to move between the standard parking area “A1” and an elevator “E,” and special parking areas “A2” that do not require vehicles to travel under one or more of beams “B” to reach an elevator “E.” As such, special parking areas “A2” may be used for parking special, oversized, or other vehicles. With additional reference to FIGS. 1A-1C, central control system 160 controls transport robots 200 to move and park vehicles such that access to elevators “E” and routing vehicles to/from elevators “E” is optimized while ensuring that special parking areas “A2” are utilized for special, oversized, or other vehicles. Central control system 160 may include a floor layout of each floor of the parking structure “P” to enable the above.

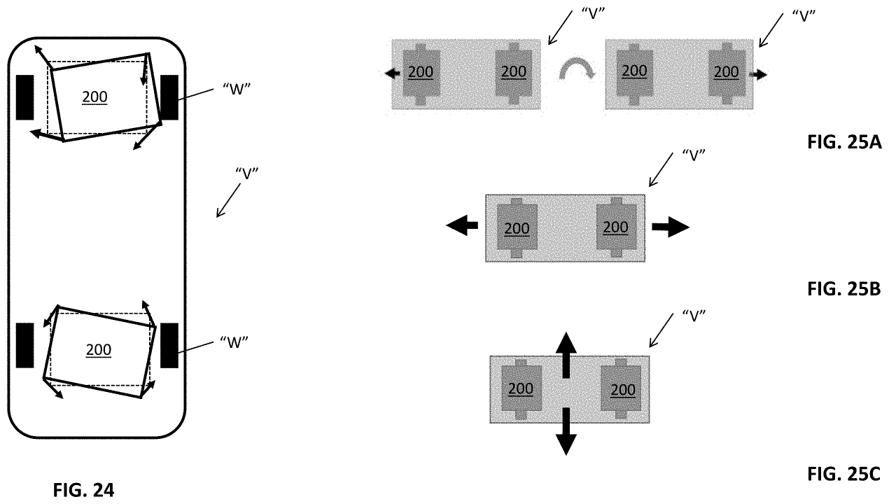

FIG. 24 illustrates a pair of transport robots 200 disposed underneath and engaged with a vehicle “V.” As illustrated, each transport robot 200 is engaged between a wheel pair “W” of the vehicle “V,” e.g., a first transport robot 200 is engaged between the front wheels “W” and a second transport robot is engaged between the rear wheel “W.” Transport robots 200 may be configured to rotate in place, as illustrated in FIG. 24, thereby rotating the vehicle “V” with a zero turning radius. With additional reference to FIGS. 25A-25C, with a pair of transport robots 200 engaged with a vehicle “V” as illustrated in FIG. 24, the transport robots 200 can effect rotation of the vehicle “V” (see FIG. 25A), movement of the vehicle in the “X” direction (see FIG. 25B), movement of the vehicle in the “Y” direction (see FIG. 25C), or, if required, movement of the vehicle in a diagonal direction including both “X” and “Y” directional components.

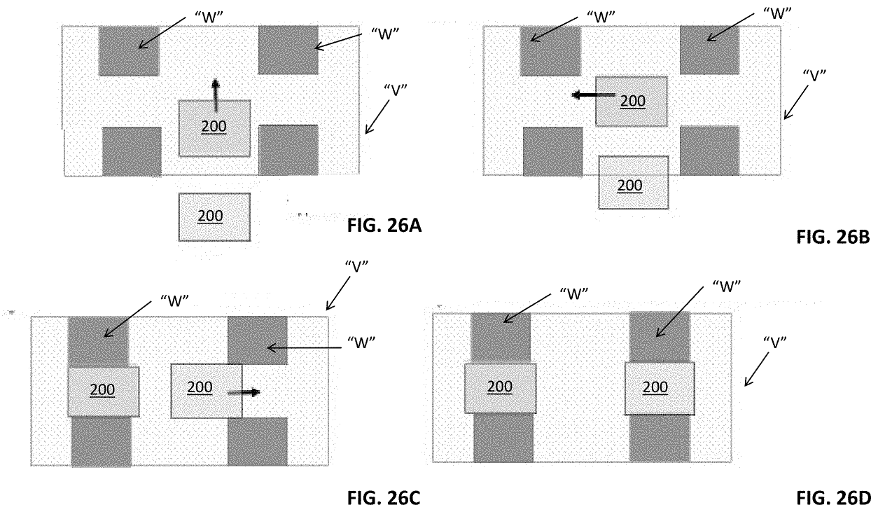

With reference to FIGS. 26A-26D, engagement of a pair of transport robots 200 between the wheel pairs of vehicle “V” is more specifically described. Although described with respect to entry from a side of the vehicle “V,” it is understood that front/rear entry is also contemplated as is one transport robot 200 entering from a side and the other transfer robot 200 entering from the front or rear. As illustrated in FIG. 26A, a first transport robot 200 is first moved transversely underneath the vehicle “V” between the front and rear wheels on a side thereof and, as illustrated in FIG. 26B, is then move rearward into position between the pair of rear wheels “W” of the vehicle “V” (although frontward movement for positioning between the pair of front wheels “W” is also contemplated). Referring to FIGS. 26C and 26D, following the first transport robot 200, a second transport robot 200 is first moved transversely underneath the vehicle “V” between the front and rear wheels on a side thereof and is then move forward into position between the pair of front wheels “W” of the vehicle “V.” Once the position illustrated in FIG. 26D is achieved, each transport robots 200 may engage the adjacent pair of wheels “W” to lift the vehicle “V” off the ground, thus permitting transport of the vehicle “V.” More specifically, the vehicle “V” may be rotated and/or translated in any suitable direction, e.g., as detailed above with respect to FIGS. 24-25C, to achieve a task.

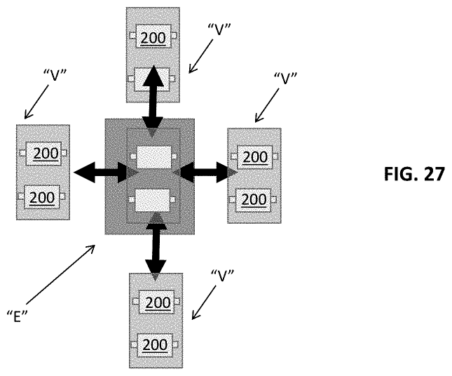

Turning to FIG. 27, a pair of transport robots 200 carrying a vehicle “V” is capable of entering an elevator “E” in any direction, e.g., from in front of the elevator “E,” from behind the elevator “E,” or from either side of the elevator “E.” This configuration adds versatility, thus minimizing the number of maneuvers required to retrieve a vehicle “V.”

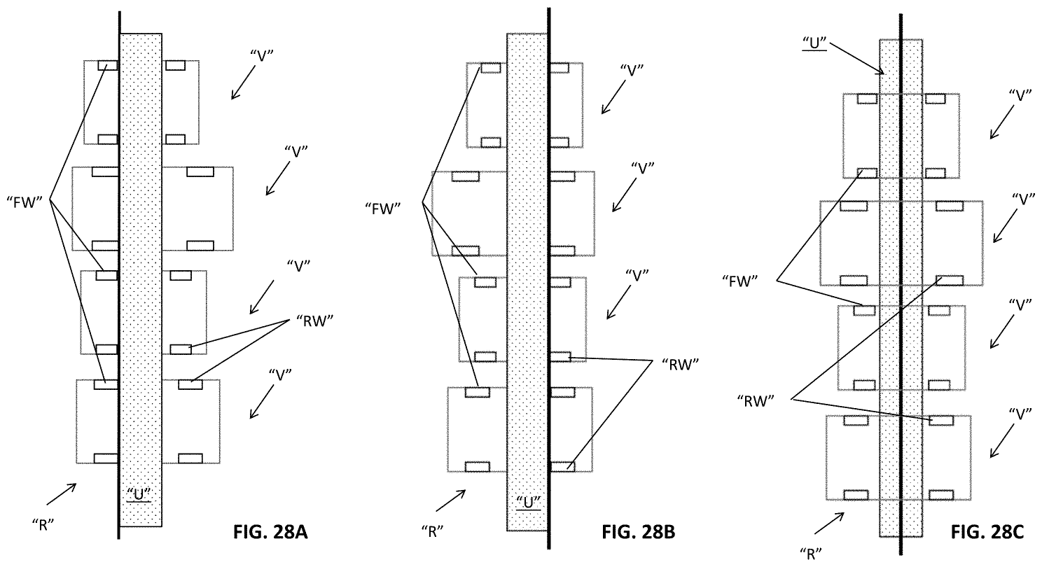

FIG. 28A-28C illustrate various alignments of a row “R” of vehicles “V” parked in accordance with the present disclosure, e.g., using automated parking system 1100 (FIGS. 19A-19C.) Each alignment defines an unobstructed path “U” underneath the row “R” of vehicles “V,” thus allowing one or more transport robots 200 (FIGS. 19A-19C) to travel along the row “R” of vehicles “V” linearly and without obstruction regardless of the size, wheel base, and/or other differences between the vehicles “V.” With respect to FIG. 28A, for example, the vehicles “V” may be aligned such that the rear ends of the front wheels “FW” of each vehicle “V” are aligned with one another. With respect to FIG. 28B, as another example, the vehicles “V” may be aligned such that the front ends of the rear wheels “RW” of each vehicle “V” are aligned with one another. Still another example illustrate in FIG. 28C provides the center lines between the front wheels “FW” and rear wheels “RW” of each vehicle “V” aligned with one another. Each of the above-noted alignments may be used to define the unobstructed path “U” underneath the row “R” of vehicles “V.”

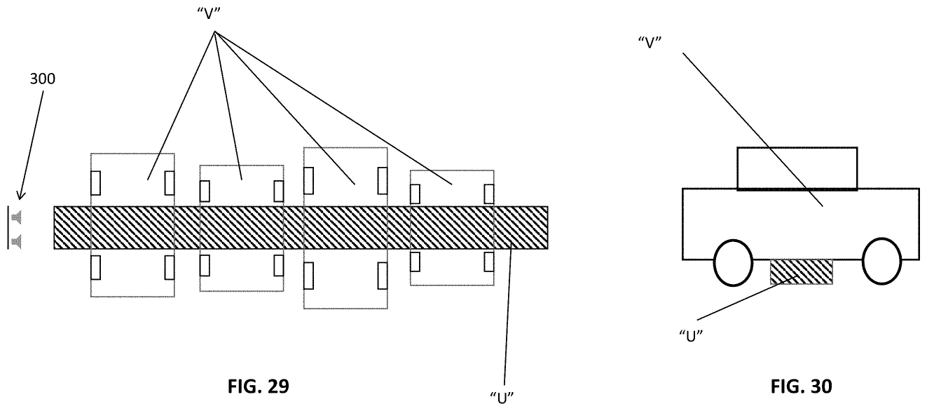

Referring to FIGS. 29 and 30, in addition to the unobstructed path “U” requiring a lateral clearance, e.g., between the front wheels “FW” and rear wheels “RW” of each vehicle “V” (see FIGS. 28A-28C), a height clearance is also required between the ground and the undercarriage of the vehicles “V” to ensure transport robots 200 (FIGS. 19A-19C) can pass underneath the vehicles “V” without damaging or getting stuck underneath the vehicles “V.” To this end, sensors 300 and associated markers (not explicitly shown), e.g., painted lines, magnetic markers, RFID markers, bar coded markers, etc., are disposed at either or both ends and/or intermittently along each row “R” of vehicles “V” to ensure minimum clearances along the unobstructed path “U” are maintained. Should one or more sensors 300 detect an insufficient clearance, e.g., as a result of an improperly parked vehicle(s) “V;” equipment such as mufflers, tail pipes, or seatbelts hanging out of a door; a flat tire having dropped the vehicle to lower vehicle ground clearance; dropped trash or other debris; etc., this information may be relayed to central control system 160 (FIGS. 1A-1C) to provide an alert, maintenance call, or the like. Alternatively or additionally, the information may be relayed to central control system 160 (FIGS. 1A-1C) and/or one or more of the transport robots 200 (FIG. 19A-19C) such that the transport robots 200 (FIGS. 19A-19C) avoid the area of insufficient clearance and, if possible, rectify the issue, e.g., by moving one or more vehicles “V.” In embodiments, transport robots 200 (FIGS. 19A-19C) utilize the above-noted markers and/or other navigation aids, e.g., painted lines, patterns on floors or walls, embedded sensors, magnets, other landmarks, etc., to facilitate navigation through the parking structure “P” (see FIGS. 28A-28C).

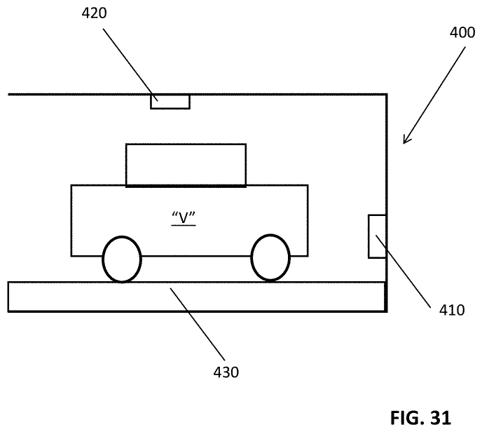

With reference to FIG. 31, a vehicle “V” is shown disposed within an entry bay 400 of automated parking system 1100 (FIG. 20), e.g., on the ground or entry/exit level of the parking structure “P” (FIG. 4). Entry bay 400 may be driven into by a customer operating the vehicle “V” or the vehicle “V” may be driverless. In either configuration, the plurality of sensors 410, 420, 430 of entry bay 400 are utilized to obtain information about the vehicle “V” and/or perform other pre-parking tasks such as: license plate reading, visual inspection, alignment/positioning measurements, height, length, and/or weight measurements, safety checks, etc. Entry bay 400 may also automatically or enable the manual input of additional information such as, for example, driver information, payment and extra service information, estimated retrieval time, etc. From entry bay 400, the vehicle “V” is transported to an elevator “E” (FIG. 20) or, if floor transfer is not required, to the parking area to be parked according to the information gathered and under the instructions of central control system 160 (FIGS. 1A-1C).

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as examples of particular embodiments. Those skilled in the art will envision other modifications within the scope and spirit of the claims appended hereto.

What is claimed is:

1. A transport robot, comprising:
a body; and
a plurality of sub-assemblies, at least one of the sub-assemblies configured to releasably mechanically engage and electrically couple with the body, each of the plurality of sub-assemblies configured to at least one of electrically or mechanically coupled to at least one other of the plurality of sub-assemblies via the body, the plurality of sub-assemblies including:
a CPU sub-assembly configured for mechanical engagement and electrical coupling with the body;
a battery sub-assembly configured for mechanical engagement and electrical coupling with the body in electrical communication with the CPU sub-assembly;
at least one powered drive sub-assembly configured for mechanical engagement and electrical coupling with the body in electrical communication with at least one of the CPU sub-assembly or the battery sub-assembly; and
at least one mechanical operator sub-assembly configured for mechanical engagement with the body and at least one of mechanical or electrical communication therewith.

2. The transport robot according to claim 1, further comprising a cover disposed about at least a portion of the body and enclosing the CPU sub-assembly, the battery sub-assembly, and the at least one powered drive sub-assembly within the body.

3. The transport robot according to claim 1, wherein the CPU sub-assembly is configured to releasably mechanically engage and electrically couple with the body.

4. The transport robot according to claim 3, wherein the CPU sub-assembly and the body include corresponding electrical connections configured to electrically connect to one another upon mechanical engagement of the CPU sub-assembly within a cavity defined within with the body.

5. The transport robot according to claim 1, wherein the battery sub-assembly is configured to releasably mechanically engage and electrically couple with the body.

6. The transport robot according to claim 5, wherein the battery sub-assembly and the body include corresponding electrical connections configured to electrically connect to one another upon mechanical engagement of the battery sub-assembly within a cavity defined within with the body.

7. The transport robot according to claim 1, wherein the at least one powered drive sub-assembly is configured to releasably mechanically engage and electrically couple with the body.

8. The transport robot according to claim 7, wherein the at least one powered drive sub-assembly is configured to slidably mechanically engage the body.

9. The transport robot according to claim 7, wherein the at least one powered drive sub-assembly includes a plug configured to releasably electrically couple with a receptacle of the body.

10. The transport robot according to claim 1, wherein the at least one powered drive sub-assembly includes a frame, a steering motor, a drive motor, and a wheel assembly.

11. The transport robot according to claim 10, wherein the at least one powered drive sub-assembly is configured to selectively disengage at least one of the steering motor or the drive motor from the wheel assembly to permit at least one of free rotation or free rolling of the wheel assembly.

12. The transport robot according to claim 1, wherein the body defines a rectangular configuration and wherein the at least one powered drive sub-assembly includes four powered drive sub-assemblies each disposed adjacent a corner of the body.

13. The transport robot according to claim 12, wherein each powered drive sub-assembly includes an “L”-shaped or “U”-shaped rail arrangement configured to mechanically slidably engage an “L”-shaped or “U”-shaped bar arrangement at one of the corners of the body.

14. The transport robot according to claim 1, wherein the at least one mechanical operator sub-assembly is configured to releasably mechanically engage the body.

15. The transport robot according to claim 1, wherein the at least one mechanical operator sub-assembly is configured to receive at least one of a mechanical input or an electrical input from the body to operate the at least one mechanical operator sub-assembly.

16. The transport robot according to claim 15, wherein the at least one mechanical operator sub-assembly includes a pair of arms configured to pivot relative to one another and the body to manipulate an object.

17. The transport robot according to claim 1, wherein the at least one mechanical operator sub-assembly includes a pair of mechanical operator sub-assemblies disposed on opposing sides of the body.

18. The transport robot according to claim 1, further comprising at least one sensor sub-assembly disposed on the body.

19. The transport robot according to claim 1, further comprising at least one pair of towing magnets disposed on the body or at least one towing electromagnet disposed on the body.

20. The transport robot according to claim 1, wherein the transport robot defines a vertical clearance of no greater than 4 inches.

21. An automated parking system, comprising:
a central control system having supervisory control and configured to provide instructions for a task to be accomplished; and
a plurality of transport robots, each transport robot configured for rotation, movement in an X-direction, and movement in a Y-direction, wherein at least one of the transport robots is configured to receive the instructions from the central control system and exercise local control to direct at least one of rotation, movement in an X-direction, or movement in a Y-direction of at least one of the transport robots to accomplish the task.

22. The automated parking system according to claim 21, wherein the supervisory control of the central control system allows the central control system to override the local control of the at least one transport robot.

23. The automated parking system according to claim 21, wherein the plurality of transport robots includes at least one pair of transport robots, each pair of transport robots including a lead transport robot and a follower transport robot.

24. The automated parking system according to claim 23, wherein the supervisory control of the central control system allows the central control system to reassign lead and follower roles amongst the plurality of transport robots.

25. The automated parking system according to claim 23, wherein the lead transport robot in each pair of transport robots leads that pair of transport robots in all aspects and wherein the follower transport robot in each pair of transport robots follows the lead transport robot of that pair in all aspects.

26. The automated parking system according to claim 21, wherein the plurality of transport robots includes at least one pair of transport robots, each pair of transport robots including a first transport robot and a second transport robot, wherein the first transport robot in each pair of transport robots controls that pair of transport robots in some aspects and is controlled by the second transport robot of that pair in other aspects.

27. The automated parking system according to claim 21, wherein the plurality of transport robots are organized into a plurality of pairs of transport robots.

28. The automated parking system according to claim 27, wherein one pair of transport robots is configured to transport a vehicle.

29. The automated parking system according to claim 27, wherein, when one of the transport robots becomes disabled, the disabled transport robot and the other transport robot paired therewith are replaced with a replacement pair of transport robots to complete the task.

30. The automated parking system according to claim 29, wherein the other transport robot paired with the disabled transport robot is configured to tow the disabled transport robot.

31. The automated parking system according to claim 27, wherein, when one of the transport robots become disabled, the other transport robot paired therewith is unpaired from the disabled robot and paired with a substitute transport robot to complete the task.

32. The automated parking system according to claim 31, wherein a tow transport robot is configured to tow the disabled transport robot.

33. The automated parking system according to claim 27, wherein a ratio of a number of pairs of transport robots to a number of parking stalls on a floor of a parking structure is up to 1:15.

34. The automated parking system according to claim 27, wherein a ratio of a number of pairs of transport robots to a number of parking stalls on a floor of a parking structure is up to 1:25.

35. The automated parking system according to claim 27, wherein a ratio of a number of pairs of transport robots to a number of parking stalls on a floor of a parking structure is up to 1:40.

36. The automated parking system according to claim 21, wherein the task to be accomplished is a housekeeping operation to organize empty spaces in a pre-determined manner.

37. The automated parking system according to claim 21, wherein the plurality of transport robots are configured to park vehicles in rows in accordance with an alignment such that each row define a linear, unobstructed path extending underneath the vehicles in that row, and wherein the alignment is one of: a front wheel alignment, a rear wheel alignment, or a center line alignment.

38. The automated parking system according to claim 37, further comprising sensors configured to sense encroachments into the unobstructed path of each row.
